(19) United States
(12) Patent Application Publication
(10) Pub. No.: US 2013/0229550 A1
(43) Pub. Date: Sep. 5, 2013

(54) DEFECTIVE PIXEL CORRECTION APPARATUS, METHOD FOR CONTROLLING THE APPARATUS, AND PROGRAM FOR CAUSING COMPUTER TO PERFORM THE METHOD

(71) Applicant: SONY CORPORATION, Tokyo (JP)

(72) Inventor: Daisuke NAKAO, Tokyo (JP)

(73) Assignee: SONY CORPORATION, Tokyo (JP)

(21) Appl. No.: 13/749,905

(22) Filed: Jan. 25, 2013

(30) Foreign Application Priority Data
Mar. 1, 2012 (JP) 2012-045736

(51) Int. Cl. H04N 5/367

(52) U.S. Cl. CPC H04N 5/367
USPC 348/247; 348/246

(57) ABSTRACT

A defective pixel correction apparatus includes a defect pattern acquisition unit configured to acquire, as a defect pattern, a pattern of positions of a plurality of defective pixels in a group of pixels used to correct a noted pixel, a pixel selection unit configured to select one or more pixels from among pixels other than the defective pixels in the group of pixels on the basis of the defect pattern, and a defective pixel correction unit configured to correct the noted defective pixel using the selected pixels.

### BACKGROUND

The present technology relates to a defective pixel correction apparatus, a method for controlling the apparatus, and a program for causing a computer to perform the method. Specifically, the present technology relates to a defective pixel correction apparatus for correcting a defective pixel in an image sensor, a method for controlling the apparatus, and a program for causing a computer to perform the method.

In traditional imaging apparatuses including an image sensor, some pixels in the image sensor may malfunction due to a manufacturing failure, entry of foreign matter, aged deterioration, or the like during manufacture or use. Examples of such malfunctioning pixels include a pixel having a lower output level corresponding to the amount of incident light (i.e., lower sensitivity) than a normal pixel and a pixel having a high output level in a shielded state (i.e., a high output level based on dark current). The former pixel forms a black spot, and the latter a white spot. Such a malfunctioning pixel (hereafter referred to as “defective pixel”) causes the degradation of image quality.

To suppress the degradation of image quality, there have been proposed defective pixel detection circuits that detect a defective pixel in an image and correct it using a pixel adjacent to the defective pixel (for example, see Japanese Unexamined Patent Application Publication No. 5-260385). Such a defective pixel detection circuit corrects a defective pixel by calculating the average value of pixels adjacent to the defective pixel and then replacing the value of the defective pixel with the average value.

### SUMMARY

However, the related art described above may have a difficulty correcting a defective pixel accurately. If a pixel adjacent to the target defective pixel is also detected as a defective pixel, use of the adjacent defective pixel for correction would modify the value of the target defective pixel to an improper value. For this reason, when a defective pixel exists adjacent to the target defective pixel, the operator has to modify the circuit or program during factory shipment or repair to prevent use of the adjacent defective pixel for correction. However, if there are many defective pixels, the number of modifications to the circuit or the like would be increased, taking much time and effort. This makes it difficult to correct the defective pixels accurately.

In view of the foregoing, the present technology has been made, and it is desirable to provide an apparatus that can correct many defective pixels accurately.

A first embodiment of the present technology provides a defective pixel correction apparatus. The defective pixel correction apparatus includes a defect pattern acquisition unit configured to acquire, as a defect pattern, a pattern of positions of a plurality of defective pixels in a group of pixels used to correct a noted pixel, a pixel selection unit configured to select one or more pixels from among pixels other than the pixels in the group of pixels on the basis of the defect pattern, and a defective pixel correction unit configured to correct the noted defective pixel using the selected pixels. The first embodiment also provides a method for controlling the defective pixel correction apparatus. As a result, there is obtained an effect of correcting the noted defective pixel due to use of the pixels selected on the basis of the defect pattern.

In the first embodiment, the defective pixel correction apparatus may further include a correction coefficient determination unit configured to determine, as a correction coefficient, a correction coefficient for calculating a correction value for a value of the noted defective pixel, for each of the selected pixels. The defective pixel correction unit may calculate the correction value using values of the selected pixels and the correction coefficients corresponding to the selected pixels. As a result, there is obtained an effect of calculating the correction value due to use of the values of the selected pixels and the correction coefficients.

In the first embodiment, the defective pixel correction apparatus may further include a defect pattern storage unit configured to store the acquired defect pattern. The correction coefficient determination unit may determine the correction coefficient on the basis of the defect pattern read from the defect pattern storage unit. As a result, there is obtained an effect of determining the correction coefficient on the basis of the defect pattern read from the defect pattern storage unit.

In the first embodiment, the defective pixel correction apparatus may further include a correction coefficient storage unit configured to store, as a correction coefficient, a coefficient for calculating a correction value for a value of the noted defective pixel, for each of the selected pixels. The defective pixel correction unit may read correction coefficients corresponding to the selected pixels from the correction coefficient storage unit and correct the noted defective pixel using the read correction coefficients and the selected pixels. As a result, there is obtained an effect of correcting the noted defective pixel due to use of the correction coefficients read from the correction coefficient storage unit and the selected pixels.

In the first embodiment, the defective pixel correction apparatus may further include a defective pixel detection unit configured to detect a defective pixel in an image. The defect pattern acquisition unit may acquire the defect pattern using the detected defective pixel as the noted defective pixel. As a result, there is obtained an effect of detecting the defective pixel.

In the first embodiment, the defective pixel correction unit may include an edge detection unit configured to detect an edge of an object in an image, a pixel exclusion unit configured to exclude, from the selected pixels, pixels in an area other than an area including the noted defective pixel of areas partitioned by the edge and output the remaining pixels, and a defective pixel correction processing unit configured to correct the noted defective pixel using the outputted pixels. As a result, there is obtained an effect of excluding, from the selected pixels, pixels in an area other than an area including the noted defective pixel.

A second embodiment of the present technology provides a correction coefficient calculation apparatus. The correction coefficient calculation apparatus includes a defect pattern acquisition unit configured to acquire, as a defect pattern, a pattern of positions of a plurality of defective pixels in a group of pixels used to correct a noted defective pixel in a student image including a defective pixel, a pixel selection unit configured to select one or more pixels from among pixels other than the defective pixels in the group of pixels on the basis of the defect pattern each time the defective pixel is noted, a target value selection unit configured to select, as a target value, a value of a pixel corresponding to the noted defective pixel from among pixels in a teacher image including no defective pixel each time the defective pixel is noted, and a correction coefficient calculation unit configured to calculate correction coefficients corresponding to the selected one or more pixels in such a manner that a correction value calculated from the selected one or more pixels and the correction coefficients matches the target value. The second embodiment also provides a method for controlling the correction coefficient calculation apparatus and a program for causing a computer to perform the method. As a result, there is obtained an effect of calculating correction coefficients for calculating a correction value.

According to the present technology, it is possible to obtain an outstanding effect of correcting many defective pixels accurately.

### BRIEF DESCRIPTION OF THE DRAWINGS

FIG. 1 is a block diagram showing an example configuration of an imaging apparatus according to a first embodiment.

FIG. 2 is a block diagram showing an example configuration of a defect pattern acquisition unit according to the first embodiment.

FIG. 3 is a block diagram showing an example configuration of a correction coefficient determination unit according to the first embodiment.

FIG. 4 is a diagram showing an example of defect pattern identification information according to the first embodiment.

FIG. 5 is a diagram showing the defect pattern identification information according to the first embodiment.

FIG. 6 is a diagram showing an example of correction coefficients according to the first embodiment.

FIGS. 7A to 7F are diagrams showing an example of defect patterns according to the first embodiment.

FIGS. 8A to 8F are diagrams showing a defective pixel correction process according to the first embodiment.

FIG. 9 is a diagram showing a specific example of defective pixels and a defect pattern according to the first embodiment.

FIG. 10 is a flowchart showing an example of a defect pattern acquisition process according to the first embodiment.

FIGS. 11A and 11B are diagrams showing examples of a defect pattern according to a modification of the first embodiment.

FIG. 12 is a block diagram showing an example configuration of a correction coefficient determination unit according to a second embodiment.

FIG. 13 is a block diagram showing an example configuration of a defective pixel correction unit according to the second embodiment.

FIG. 14 is a diagram showing an example of correction coefficients corresponding to defective pixels according to the second embodiment.

FIG. 15 is a flowchart showing an example of a defect pattern acquisition process and a correction coefficient selection process according to the second embodiment.

FIG. 16 is a block diagram showing an example configuration of an imaging apparatus according to a third embodiment.

FIG. 17 is a block diagram showing an example configuration of a defective pixel correction unit according to the third embodiment.

FIG. 18 is a diagram showing an example of selected pixel designation code according to the third embodiment.

FIG. 19 is a diagram showing a defective pixel correction process according to the third embodiment.

FIG. 20 is a block diagram showing an example of a correction coefficient learning apparatus according to a fourth embodiment.

FIG. 21 is a block diagram showing an example of a correction coefficient calculation unit according to the fourth embodiment.

FIG. 22 is a block diagram showing an example of a normal equation generation unit according to the fourth embodiment.

FIG. 23 is a diagram showing an example of the total value of matrix elements according to the fourth embodiment.

FIG. 24 is a flowchart showing an example of a correction coefficient learning process according to the fourth embodiment.

### DETAILED DESCRIPTION OF EMBODIMENTS

Now, embodiments of the present technology (hereafter simply referred to as embodiments) will be described. The description will be made in the following order:

1. First embodiment (example where a defect pattern is acquired, an image is captured, and then a correction coefficient is selected);

2. Second embodiment (example where a defect pattern is acquired, a correction coefficient is selected, and then an image is captured);

3. Third embodiment (example where a defect pattern is acquired and a correction coefficient is determined in such a manner that image quality does not degrade); and

4. Fourth embodiment (example where a defect pattern is acquired and a correction coefficient is learned).

### 1. First Embodiment

### Example Configuration of Imaging Apparatus

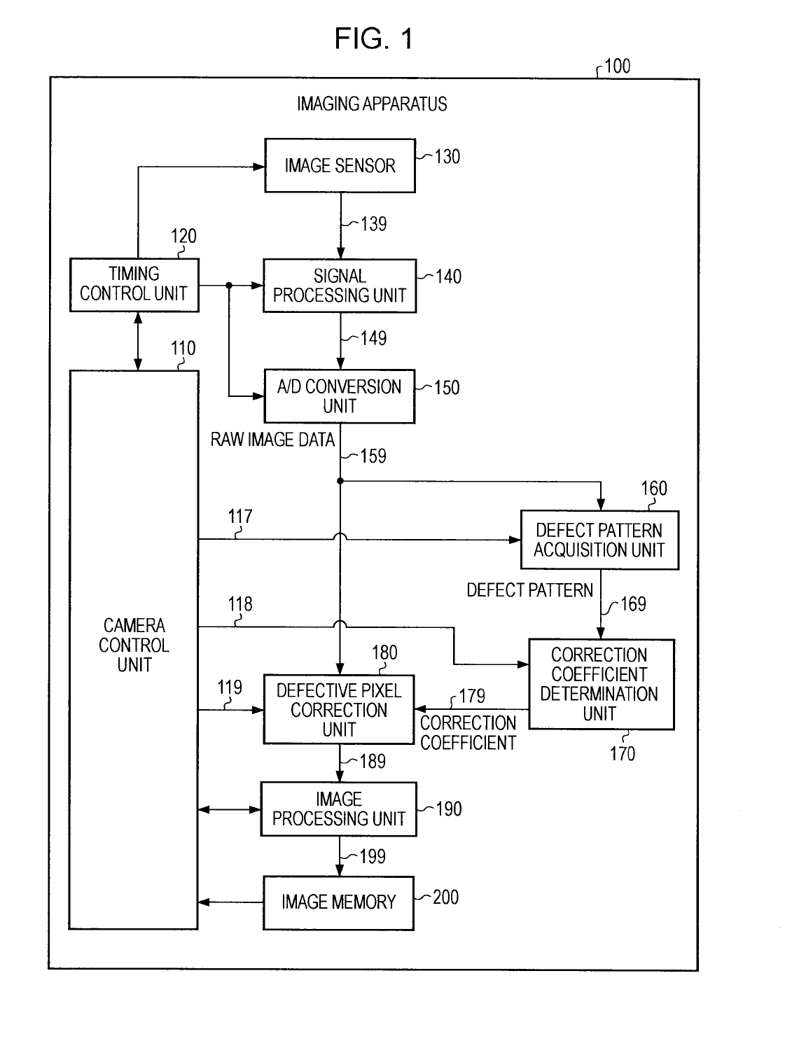

FIG. 1 is a block diagram showing an example configuration of an imaging apparatus 100 according to the first embodiment. The imaging apparatus 100 is configured to capture images and includes a camera control unit 110, a timing control unit 120, an image sensor 130, a signal processing unit 140, and an A/D conversion unit 150. The imaging apparatus 100 also includes a defect pattern acquisition unit 160, a correction coefficient determination unit 170, a defective pixel correction unit 180, an image processing unit 190, and an image memory 200.

The camera control unit 110 controls the entire imaging apparatus 100. The camera control unit 110 controls the timing control unit 120 to cause it to capture an image and also controls the image processing unit 190 or the like to cause it to process an image.

The camera control unit 110 also outputs a timing signal for indicating the timing at which to acquire a defect pattern, to the defect pattern acquisition unit 160 via a signal line 117. A defect pattern will be described later. A timing different from the timing at which an image is captured based on a user operation (a depression of the shutter button, etc.) is set as the timing at which to acquire a defect pattern. Specific examples of the defect pattern acquisition timing include during factory shipment, during repair, at power-on of the imaging apparatus 100, and at completion of an image capture by a user operation.

The camera control unit 110 also outputs a timing signal for indicating the timing at which to select a pixel, to the correction coefficient determination unit 170 via a signal line 118. The term “select” refers to determining available pixels for correction in the pixels of the image on the basis of a defect pattern. The camera control unit 110 also outputs a timing signal for indicating the timing at which to correct the defective pixel on the basis of the selected pixels, to a defective pixel correction unit 180 via a signal line 119. The timing at which an image is captured based on a user operation, for example, is set as the timing at which to select or correct a pixel.

The timing control unit 120 controls the timing at which to drive the image sensor 130, the signal processing unit 140, and the A/D conversion unit 150, on the basis of the type of an operation performed on the shutter button and the shutter speed.

The image sensor 130 photoelectrically converts incident light and outputs the resulting electrical signal to the signal processing unit 140 via a signal line 139. The image sensor 130 can be realized by a charge coupled device (CCD), a complementary metal oxide semiconductor (CMOS) sensor, or the like.

The signal processing unit 140 performs correlated double sampling (CDS) or automatic gain control (AGC) on the electrical signal provided by the image sensor 130. The signal processing unit 140 outputs the resulting analog signal to the A/D conversion unit 150 via a signal line 149.

The A/D conversion unit 150 converts the analog signal from the signal processing unit 140 into a digital signal. The A/D conversion unit 150 outputs the resulting digital signal serving as image data to the defect pattern acquisition unit 160 and the defective pixel correction unit 180 via a signal line 159. The image data outputted by the A/D conversion unit 150 has yet to be subjected to image processing, such as demosaicing or compression, and therefore is called raw image data.

Under the control of the camera control unit 110, the defect pattern acquisition unit 160 regards defective pixels in the image data (e.g., raw image data) as pixels to be corrected and acquires a defect pattern for each defective pixel. In the correction process, the pixels noted as being pixels to be corrected will be referred to as “noted pixels.” The term “defective pixel” refers to a pixel having an abnormal output level, for example, a pixel having lower sensitivity than a normal pixel or a pixel having a high output level in a shielded state (that is, a high output level based on dark current). The term “defect pattern” refers to a position pattern of multiple defective pixels in a group of pixels used to correct the noted pixel (such a group will be referred to as “correction block). In the correction process, a group of pixels having a given positional relationship with the noted pixel (e.g., a group of pixels within a given distance from the noted pixel) is used as a correction block. Accordingly, a correction block located in a different position is used for each noted pixel. Accordingly, in these correction blocks, a defect pattern is acquired for each defective pixel. The defect pattern acquisition unit 160 outputs the defect pattern acquired for each defective pixel to the correction coefficient determination unit 170 via a signal line 169.

Under the control of the camera control unit 110, the correction coefficient determination unit 170 selects one or more available pixels to correct each noted pixel, from among pixels other than defective pixels in a corresponding correction block on the basis of a corresponding defect pattern and determines a correction coefficient for each of the pixels selected. The correction coefficient determination unit 170 outputs the correction coefficient determined for each selected pixel to the defective pixel correction unit 180 via a signal line 179. The term “correction coefficient” refers to a coefficient for calculating a correction value for the value of a defective pixel. For example, if the average value of the selected pixels is used as a correction value, the same value is set to all correction coefficients.

The defective pixel correction unit 180 corrects the noted pixel using the selected pixels under the control of the camera control unit 110. Specifically, the defective pixel correction unit 180 corrects the noted pixel by calculating a correction value q using Formula 1 below and then replacing the value of the noted pixel with the correction value q.

$$q = {\sum }_{n = 1}^{8} {a}_{n} {p}_{n} + b \qquad ( 1 )$$

In Formula 1, pₙ represents the value of the n-th selected pixel; aₙ a real correction coefficient corresponding to pₙ; and b a real constant. For example, if the average of the values pₙ of the selected pixels is used as a correction value, the same value is set to all aₙ, and “0” is set to b. Assuming that the value of the noted pixel is replaced with the average value, if the number of selected pixels is eight, “⅛” is set to each correction coefficient aₙ. If the number of selected pixels is two, “½” is set to correction coefficients aₙ corresponding to the selected pixels.

If an accurate correction value is not calculated using only correction coefficients, the correction value q is adjusted using the value of b. For example, if the pixels in the correction block vary in sensitivity, an accurate correction value q is not calculated using the average value of the selected pixels. For this reason, the correction value q is adjusted using b.

The defective pixel correction unit 180 outputs the defective pixel-corrected image data to the image processing unit 190 via a signal line 189.

The image processing unit 190 performs image processing, such as demosaicing or white balance adjustment, on the corrected image data under the control of the camera control unit 110. The image processing unit 190 then outputs the resulting image data to the image memory 200 via a signal line 199. The image memory 200 stores the image data.

### Example Configuration of Defect Pattern Acquisition Unit

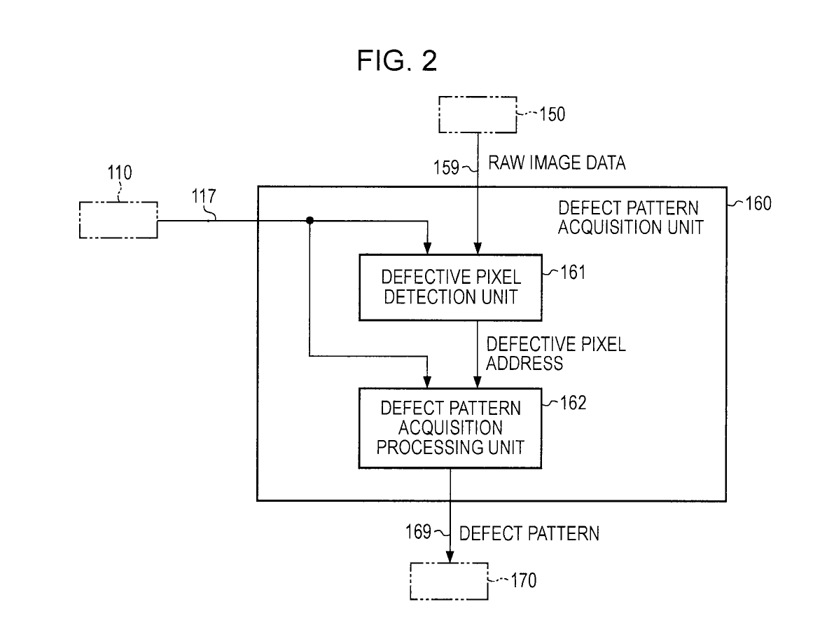

FIG. 2 is a block diagram showing an example configuration of the defect pattern acquisition unit 160 according to the first embodiment. The defect pattern acquisition unit 160 includes a defective pixel detection unit 161 and a defect pattern acquisition processing unit 162. The defect pattern acquisition unit 160 is realized, for example, by execution of a predetermined program by a processor in the imaging apparatus 100. The defect pattern acquisition process is very complicated and includes many types of processes as compared to the process of only detecting defective pixels. Accordingly, realizing this process using a hardware circuit involves the use of a large-scale circuit, such as an image processing LSI (large-scale integration). In contrast, realizing the defect pattern acquisition process using software prevents an increase in the number of hardware circuits.

The defective pixel detection unit 161 detects defective pixels in image data. For example, the defective pixel detection unit 161 detects, as defective pixels, pixels having values not less than the upper limit in image data generated from an image captured with the lens of the imaging apparatus 100 shaded by the shutter or the like. The defective pixels thus detected are called white spots. The defective pixel detection unit 161 also detects, as defective pixels, pixels having values less than the lower limit in image data generated from an image captured with a uniform amount of light entering the lens. The defective pixels thus detected are called black spots. The defective pixel detection unit 161 outputs the addresses of these defective pixels (e.g., their coordinates in the image data) to the defect pattern acquisition processing unit 162.

The defective pixel detection unit 161 may detect defective pixels using methods different from the method of comparing each pixel value with the upper or lower limit. For example, the defective pixel detection unit 161 notes any pixel in image data where pixels are Bayer-arranged and calculates the average value of pixels except for the noted pixel in a group of pixels having the same color as the noted pixel around the noted pixel (such a group will be referred to as “detection block”). For example, if the coordinates of the noted pixel is (x, y), the detection block is a group of nine pixels: (x−2,y−2), (x,y−2), (x+2,y−2), (x−2,y), (x,y), (x+2,y), (x−2,y+2), (x,y+2), and (x+2,y+2). The reason why the detection block does not include pixels adjacent to the noted pixel is that the adjacent pixels have different colors from that of the noted pixel in the Bayer arrangement. It is assumed that for any of an R (red) pixel, a G (green) pixel, and a B (blue) pixel, detection blocks have the same shape and size. If the absolute value of the difference between the average value calculated in the detection block and the value of the noted pixel is not less than the threshold, the defective pixel detection unit 161 determines that the noted pixel is a defective pixel.

While it is assumed that detection blocks have the same shape and size through R, G, and B pixels, the shape or size of detection blocks may vary among the pixel colors. This is because in a Bayer arrangement, the respective numbers of R and B pixels differ from the number of G pixels in an image. Specifically, if the noted pixel is an R pixel or B pixel, the nine R pixels or nine B pixels are detected in the 5×5 area centering on the noted pixel and then used as a detection block; if the noted pixel is a G pixel, 13 G pixels are detected in the 5×5 area centering on the noted pixel and then used as a detection block.

The defective pixel detection unit 161 may switch between the above-mentioned two detection methods as necessary to detect defective pixels. The former method, which compares a pixel value with the upper limit or lower limit, is difficult to use after factory shipment. For this reason, it is used, for example, during factory shipment or repair. On the other hand, the latter method, which compares the absolute value of the difference between the value of the noted pixel and the average value, with the threshold, is used, for example, when the imaging apparatus 100 is powered on or when an image capture is completed based on a user operation.

The defect pattern acquisition processing unit 162 detects a position pattern of multiple defective pixels in the group of pixels used to correct the noted pixel (correction block) and regards the position pattern as a defect pattern. For example, if the coordinates of the noted pixel are (x,y), the correction block is a group of nine pixels: (x−2,y−2), (x,y−2), (x+2,y−2), (x−2,y), (x,y), (x+2,y), (x−2,y+2), (x,y+2), and (x+2,y+2). It is assumed that for any of R, G, and B pixels, correction blocks have the same shape and size. The shape or size of correction blocks may also vary among the pixel colors. The defect pattern acquisition processing unit 162 determines to which of predefined defect patterns the position pattern of the defective pixels in the correction block corresponds. The defect pattern acquisition processing unit 162 notes each of the detected defective pixels and determines a defect pattern for each defective pixel. The defect pattern acquisition processing unit 162 then outputs defect pattern identification information for identifying the defect pattern determined for each defective pixel, to the correction coefficient determination unit 170. The defect pattern acquisition processing unit 162 is an example of the defect pattern acquisition unit in the claims.

While the defect pattern acquisition unit 160 includes the defective pixel detection unit 161, it may include a defective pixel storage unit for storing the address of a previously detected defective pixel, in place of the defective pixel detection unit 161.

The shapes and sizes of detection and correction blocks are not limited to those described above. For example, a detection block or correction block may be a group of five pixels: (x,y−2), (x−2,y), (x+2,y), (x,y), and (x,y+2). A detection block and a correction block do not have to have the same shape or size.

### Example Configuration of Correction Coefficient Determination Unit

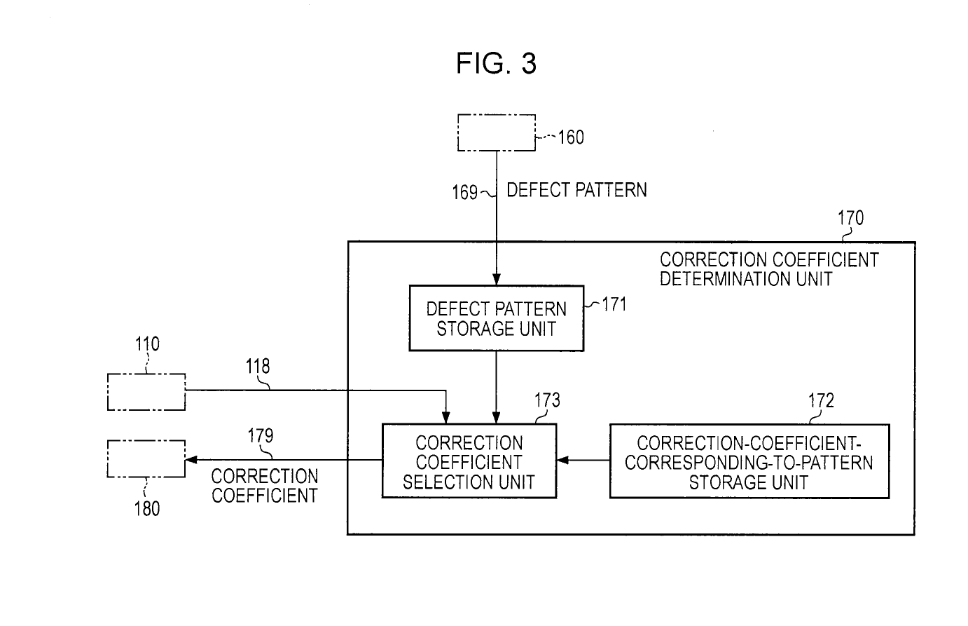

FIG. 3 is a block diagram showing an example configuration of the correction coefficient determination unit 170. The correction coefficient determination unit 170 includes a defect pattern storage unit 171, a correction-coefficient-corresponding-to-pattern storage unit 172, and a correction coefficient selection unit 173.

The defect pattern storage unit 171 stores the defect pattern acquired by the defect pattern acquisition unit 160 for each defective pixel. The correction-coefficient-corresponding-to-pattern storage unit 172 stores correction coefficients corresponding to each defect pattern. A correction coefficient is set to each pixel in a correction block. Note that a value “0” is set to pixels which are not used for correction (e.g., defective pixels or pixels having low correlation).

The correction coefficient selection unit 173 selects correction coefficients for each defect pattern when an image is captured based on a user operation. Specifically, the correction coefficient selection unit 173 reads a defect pattern for each defective pixel from the defect pattern storage unit 171 and then reads a set of correction coefficients corresponding to the read defect pattern from the correction-coefficient-corresponding-to-pattern storage unit 172. The correction coefficient selection unit 173 then outputs the read set of correction coefficients to the defective pixel correction unit 180.

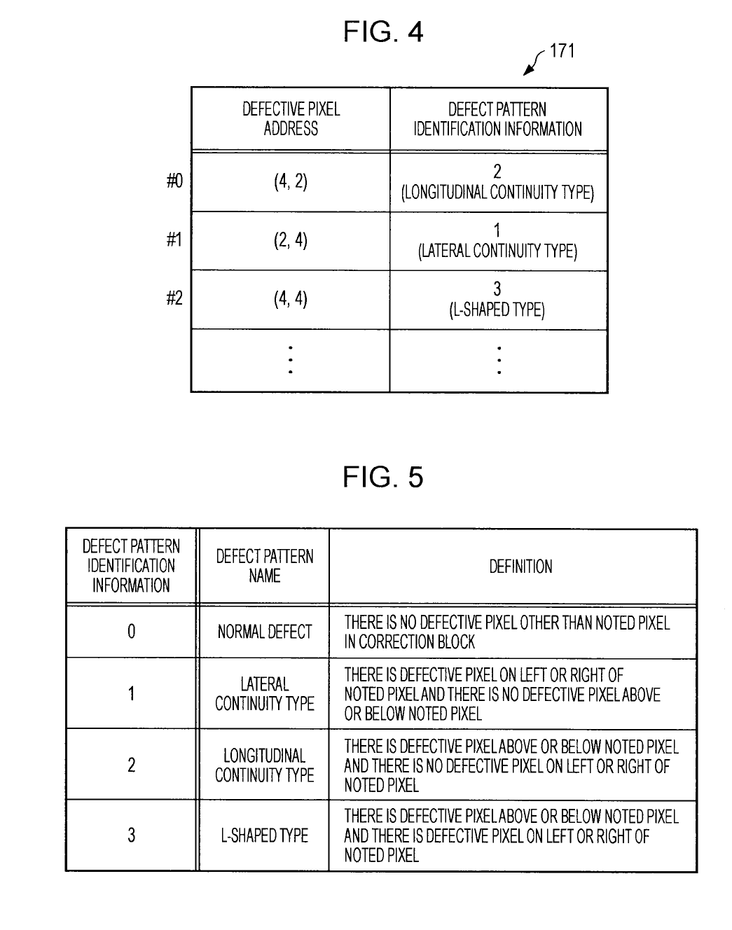

FIG. 4 is a diagram showing an example of defect pattern identification information stored in the defect pattern storage unit 171 according to the first embodiment. As shown in FIG. 4, pieces of defect pattern identification information are stored in the defect pattern storage unit 171 in a manner corresponding to the addresses of defective pixels.

FIG. 5 is a diagram showing defect pattern identification information according to the first embodiment. Any one of values “0” to “3,” for example, is set to defect pattern identification information. Of these values, the value “0” indicates that the defect pattern is a normal defect. The term “normal defect” refers to a defect pattern where there is no defective pixel other than the noted pixel in the correction block.

The value “1” indicates that the defect pattern is of lateral continuity type. Lateral continuity type refers to a defect pattern where there is a defective pixel at one of (x−2,y) and (x+2,y) on the right and left sides of the noted pixel and where there is no defective pixel at any of (x,y−2) and (x,y+2) above and below the noted pixel.

The value “2” indicates that the defect pattern is of longitudinal continuity type. Longitudinal continuity type refers to a defect pattern where there is a defective pixel at one of (x,y−2) and (x,y+2) above and below the noted pixel and where there is no defective pixel at any of (x−2,y) and (x+2,y) on the right and left sides of the noted pixel.

The value “3” indicates that the defect pattern is of L-shaped type. L-shaped type refers to a defect pattern where there is a defective pixel at one of (x,y−2) and (x,y+2) above and below the noted pixel and where there is a defective pixel at one of (x−2,y) and (x+2,y) on the right and left sides of the noted pixel.

Note that if there is detected a defect pattern which is not any of the above-mentioned types, the defect pattern is classified into a defect pattern to which the same set of correction coefficients is applicable. For example, if there is detected a defect pattern where there is one defective pixel other than the noted pixel and where the defective pixel is located in a position to which the noted pixel is inclined ((x+2,y+2), etc.), the defect pattern is classified into lateral continuity type or longitudinal continuity type. The number of the types of defect pattern is not limited to four and may be a number other than four.

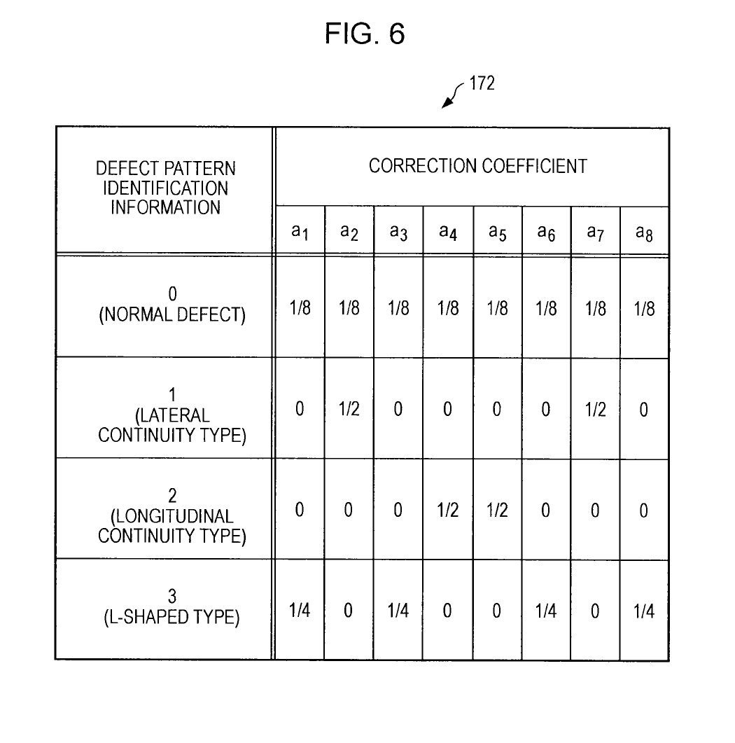

FIG. 6 is a diagram showing an example of correction coefficients according to the first embodiment. A set of correction coefficients a₁ to a₈, for example, is stored for each defect pattern in the correction-coefficient-corresponding-to-pattern storage unit 172. The correction coefficients a₁ to a₈ are correction coefficients corresponding to pixels at (x−2,y−2), (x,y−2), (x+2,y−2), (x−2,y), (x+2,y), (x−2,y+2), (x,y+2), and (x+2,y+2). In the correction of a defective pixel, a correction coefficient is a factor by which the value of a corresponding pixel is multiplied. It is assumed that for all defect patterns, “0” is set to the value of b in Formula 1. Note that the value of b may be further stored for each defect pattern in the correction-coefficient-corresponding-to-pattern storage unit 172.

If the defect pattern is a normal defect, “⅛”, for example, is set to each of a₁ to a₈. In this case, the value of the noted pixel is replaced with the average value of pixels other than the noted pixel in the correction block, which is calculated using Formula 1.

If the defect pattern is of lateral continuity type, “½,” for example, is set to a₂ and a₇, and “0” to the other coefficients. In this case, the value of the noted pixel is replaced with the average value of pixels above and below the noted pixel, which is calculated using Formula 1.

If the defect pattern is of longitudinal continuity type, “½,” for example, is set to a₄ and a₅, and “0” to the other coefficients. In this case, the value of the noted pixel is replaced with the average value of pixels on the left and right sides of the noted pixel, which is calculated using Formula 1.

If the defect pattern is of L-shaped type, “¼,” for example, is set to a₁, a₃, a₆, and a₈. In this case, the value of the noted pixel is replaced with the average value of pixels in the upper-left, upper-right, lower-left, and lower-left of the noted pixel, which is calculated using Formula 1.

While the number of the correction coefficients a₁ to a₈ is eight, it is not limited to eight. For example, the number of correction coefficients may be switched between 8 and 12 depending on the color of the noted pixel. This is because, as described above, the respective numbers of R and B pixels differ from the number of G pixels in a Bayer-arranged image. Specifically, if the noted pixel is R or B, there are eight pixels having the same color as the noted pixel except for the noted pixel in the 5×5 block centering on the noted pixel; if the noted pixel is G, there are 12 such pixels. To switch the number of correction coefficients, the defect pattern acquisition unit 160 further acquires, for each defective pixel, color identification information for identifying the pixel color. Moreover, for R and B defective pixels, eight correction coefficients are stored for each defect pattern in the correction-coefficient-corresponding-to-pattern storage unit 172; for G defective pixels, 12 correction coefficients are stored for each defect pattern therein. The correction coefficient selection unit 173 selects a set of correction coefficients in accordance with the color of the noted pixel and the defect pattern.

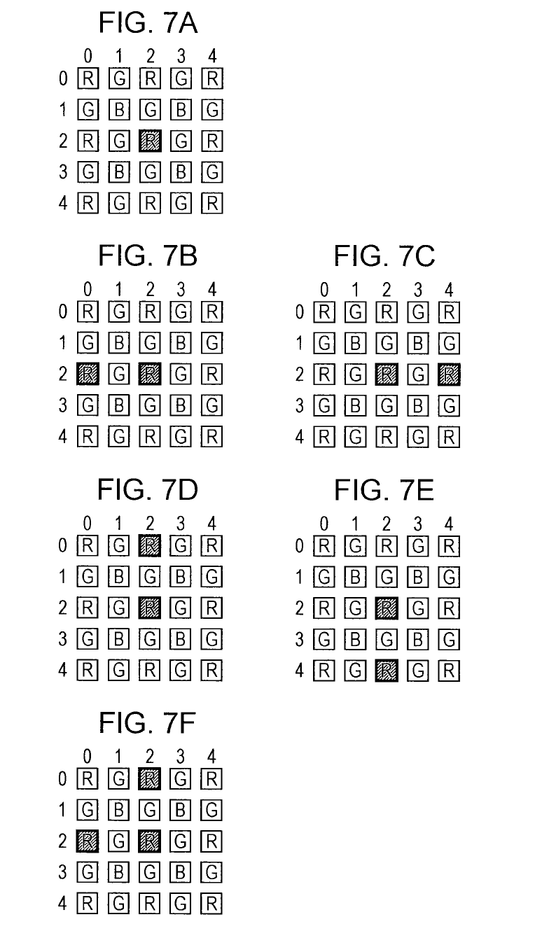

FIGS. 7A to 7F are diagrams showing examples of a defect pattern according to the first embodiment. In FIGS. 7A to 7F, the center pixel of a group of 5×5 pixels is the noted pixel. The noted pixel and pixels having the same color as the noted pixel in the group of 5×5 pixels are pixels constituting a correction block. The hatched pixels are defective pixels.

FIG. 7A is a diagram showing an example defect pattern which is classified into a normal defect. As shown in FIG. 7A, if there is no defective pixel other than the noted pixel in a correction block, a normal pixel defect pattern is acquired.

FIGS. 7B and 7C are diagrams showing examples defect patterns which are classified into lateral continuity type. As shown in FIG. 7B, if there is a defect pattern on the left of the noted pixel and if there is no defective pixel above or below the noted pixel, a lateral continuity-type defect pattern is acquired. Similarly, as shown in FIG. 7C, if there is a defect pattern on the right of the noted pixel and if there is no defective pixel above or below the noted pixel, a lateral continuity-type defect pattern is acquired.

FIGS. 7D and 7E are diagram showing example defect patterns which are classified into longitudinal continuity type. As shown in FIG. 7D, if there is a defect pattern above the noted pixel and if there is no defective pixel on the left or right of the noted pixel, a longitudinal continuity-type defect pattern is acquired. Similarly, as shown in FIG. 7E, if there is a defect pattern below the noted pixel and if there is no defective pixel on the left or right of the noted pixel, a longitudinal continuity-type defect pattern is acquired.

FIG. 7F is a diagram showing an example defect pattern which is classified into L-shaped type. As shown in FIG. 7F, if there is a defect pattern above the noted pixel and if there is a defective pixel on the left of the noted pixel, an L-shaped-type defect pattern is acquired.

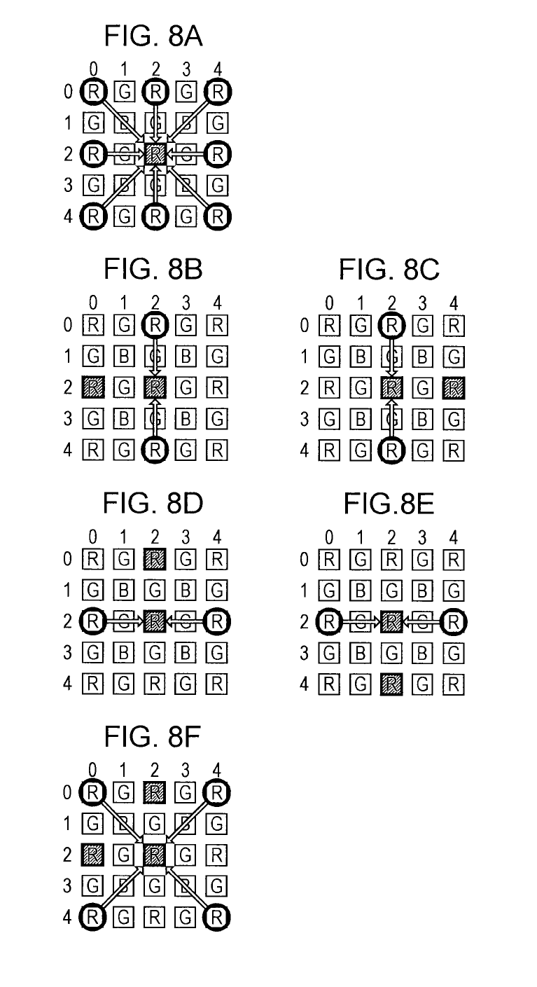

FIGS. 8A to 8F are diagrams showing a defective pixel correction process according to the first embodiment. The positions of the noted pixels and the shapes and sizes of the correction blocks are similar to those in FIGS. 7A to 7F. The circled pixels are selected available pixels for correction.

FIG. 8A is a diagram showing an example of selected pixels in the case of a normal defect. As shown in FIG. 8A, in the case of a normal defect, eight pixels other than the noted pixel are selected for correction. FIGS. 8B and 8C are diagrams showing examples of selected pixels in the case of lateral continuity type. As shown in FIGS. 8B and 8C, in the case of lateral continuity type, pixels above and below the noted pixel are selected for correction. FIGS. 8D and 8E are diagrams showing examples of selected pixels in the case of longitudinal continuity type. As shown in FIGS. 8D and 8E, in the case of longitudinal continuity type, pixels on the left and right of the noted pixel are selected for correction. FIG. 8F is a diagram showing an example of selected pixels in the case of L-shaped type. As shown in FIG. 8F, in the case of L-shaped type, pixels on the upper left, upper right, lower left, and lower right of the noted pixel are selected for correction.

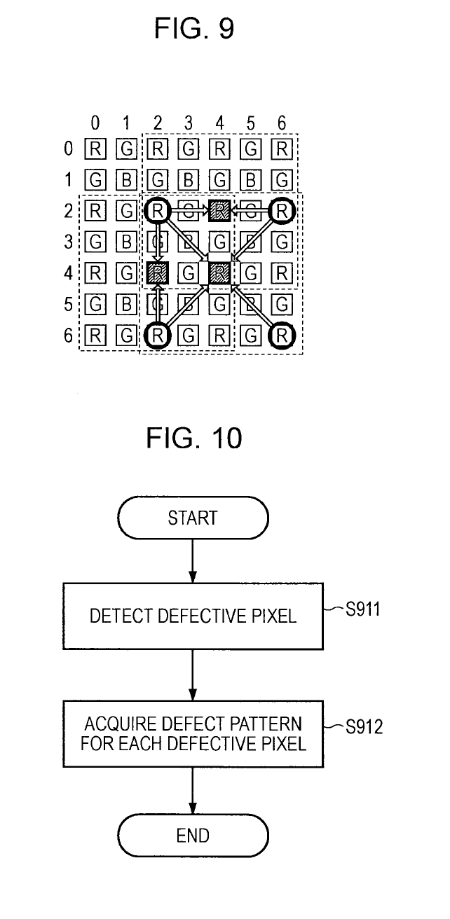

FIG. 9 is a diagram showing a specific example of defective pixels and a defect pattern detected in the first embodiment. In FIG. 9, pixels having the same color in an area enclosed by a dotted line are pixels constituting a correction block. The circled pixels are selected available pixels for correction. Assume that defective pixels are detected in positions (4,2), (2,4), and (4,4) in an area composed of 7×7 pixels at coordinates (0,0) to (6,6).

Note the defective pixel at (4,2). A group of pixels having the same color as that defective pixel in a 5×5 area located at (2,0) to (6,4) is set as a correction block. In this correction block, there is a defective pixel at (4,4) below the noted pixel at (4,2); there is no defective pixel on the left or right of the noted pixel. Accordingly, longitudinal continuity type is acquired as a defect pattern corresponding to the defective pixel at (4,2).

Next, note a defective pixel at (2,4). A group of pixels having the same color as that defective pixel in a 5×5 area at (0,2) to (4,6) is set as a correction block. In this correction block, there is a defective pixel at (4,4) on the right of the noted pixel at (2,4), while there is no defective pixel above or below the noted pixel. For this reason, lateral continuity type is acquired as a defect pattern corresponding to the defective pixel at (2,4).

Next, note a defective pixel at (4,4). A group of pixels having the same color as that defective pixel in a 5×5 area at (2,2) to (6,6) is set as a correction block. In this correction block, there is a defective pixel at (4,2) above the noted pixel at (4,4) and a defective pixel at (2,4) on the left thereof. For this reason, L-shaped type is acquired as a defect pattern corresponding to the defective pixel at (4,4).

### Example Operation of Imaging Apparatus

FIG. 10 is a flowchart showing an example of a defect pattern acquisition process performed by the defect pattern acquisition unit 160 according to the first embodiment. This defect pattern acquisition process starts when the camera control unit 110 indicates the timing at which a defect pattern is acquired.

The defect pattern acquisition unit 160 detects defective pixels in the image sensor (step S911). The defect pattern acquisition unit 160 then acquires a defect pattern for each defective pixel (step S912). The defect pattern acquisition unit 160 then completes the defect pattern acquisition process.

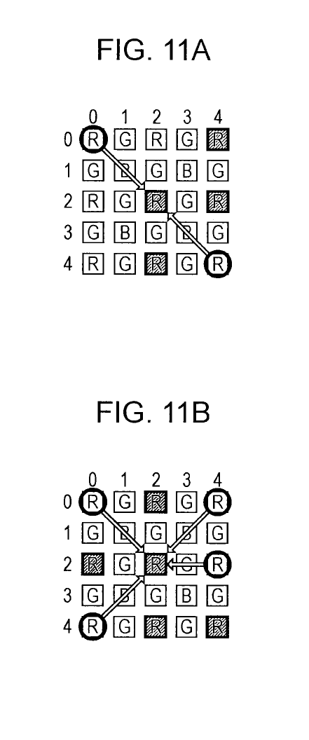

While the defect pattern acquisition unit 160 acquires a normal defect, a lateral continuity-type defect pattern, a longitudinal continuity-type defect pattern, or an L-shaped-type defect pattern, it may acquire other types of defect pattern. For example, it may acquire a pattern where defective pixels are located on the upper right and right of and below the noted pixel, as shown in FIG. 11A. In this case, pixels on the lower left and lower right of the noted pixel, for example, are selected for correction. For another example, it may acquire a pattern where defective pixels are located on the left and lower right of the noted pixel and above and below the noted pixel, as shown in FIG. 11B. In this case, pixels other than the defective pixels in the correction block are selected for correction.

As seen above, according to the first embodiment of the present technology, the imaging apparatus 100 can correct a noted pixel by selecting pixels other than defective pixels from among the pixels in a correction block on the basis of a defect pattern corresponding to the noted pixel and then using the pixels selected. This prevents the defective pixels from being used for correction, allowing the noted pixel to be corrected accurately. Further, even if there are many defective pixels, it is not necessary to modify the circuit or program to correct the defective pixels. As a result, increases in time and effort are prevented.

### 2. Second Embodiment

### Example Configuration of Correction Coefficient Determination Unit

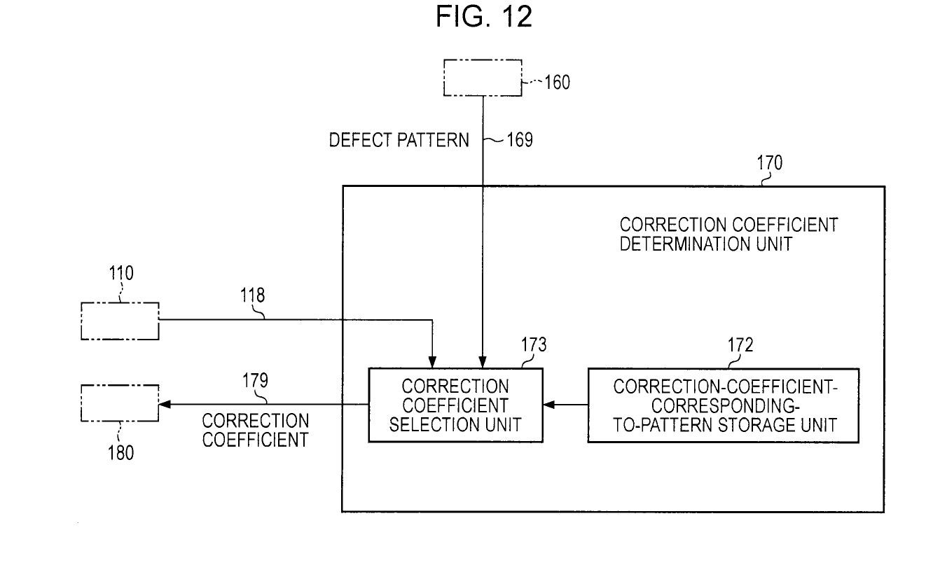

FIG. 12 is a block diagram showing an example configuration of a correction coefficient determination unit according to a second embodiment. In the first embodiment described above, the imaging apparatus 100 acquires a defect pattern prior to an image capture and performs selection of correction coefficients and correction of defective pixels during the image capture. An imaging apparatus 100 according to the second embodiment differs from that according to the first embodiment in that it selects correction coefficients prior to imaging and performs correction during imaging. Further, a correction coefficient determination unit 170 according to the second embodiment differs from that according to the first embodiment in that it does not include a defect pattern storage unit 171. Furthermore, a correction coefficient selection process according to the second embodiment differs from that according to the first embodiment in that it is performed by software.

### Example Configuration of Defective Pixel Correction Unit

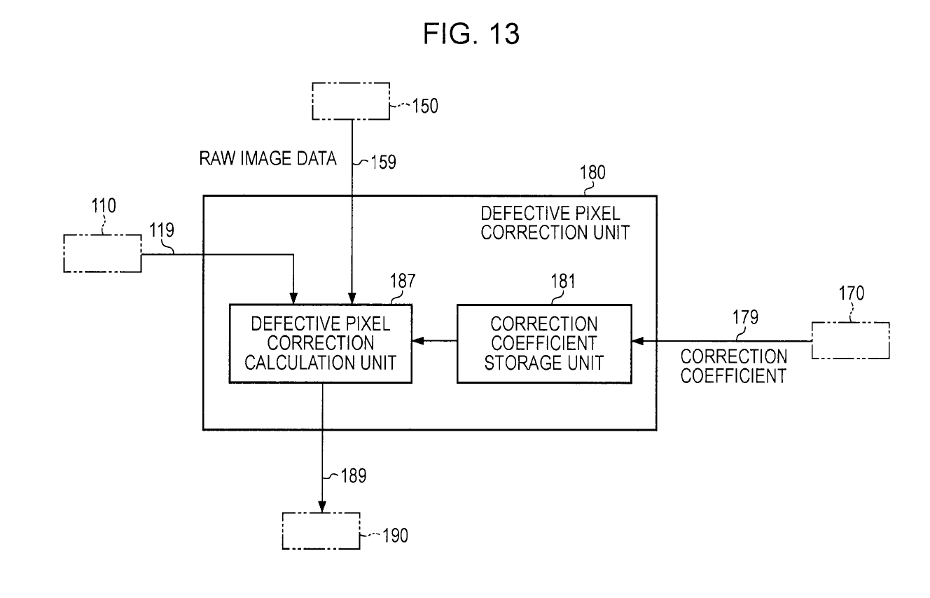

FIG. 13 is a block diagram showing an example configuration of a defective pixel correction unit 180 according to the second embodiment. The defective pixel correction unit 180 includes a correction coefficient storage unit 181 and a defective pixel correction calculation unit 187.

The correction coefficient storage unit 181 stores a set of correction coefficients for each defective pixel. The defective pixel correction calculation unit 187 reads a set of correction coefficients corresponding to a defective pixel from the correction coefficient storage unit 181 at the timing at which an image is captured based on a user operation and then corrects the defective pixel using Formula 1.

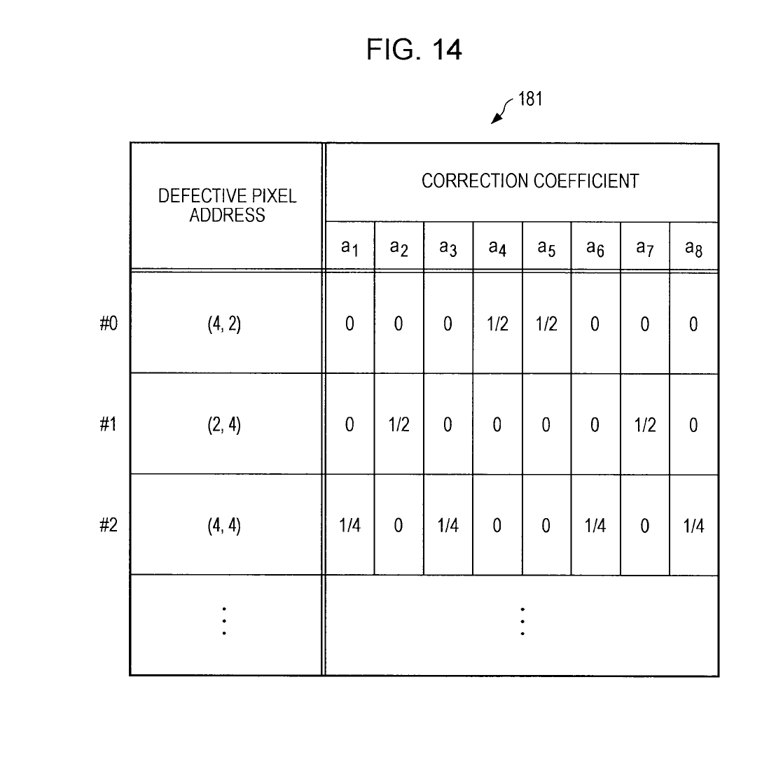

FIG. 14 is a diagram showing an example of correction coefficients corresponding to each defective pixel according to the second embodiment. Correction coefficients a₁ to aₛ are stored for the address of each defective pixel in the correction coefficient storage unit 181. For example, when longitudinal continuity type is acquired as a defect pattern corresponding to a defective pixel at (4,2), a set of correction coefficients corresponding to longitudinal continuity type (a set where only a₄ and a₅ are “½”) is stored in a manner corresponding to that defective pixel.

### Example Operation of Imaging Apparatus

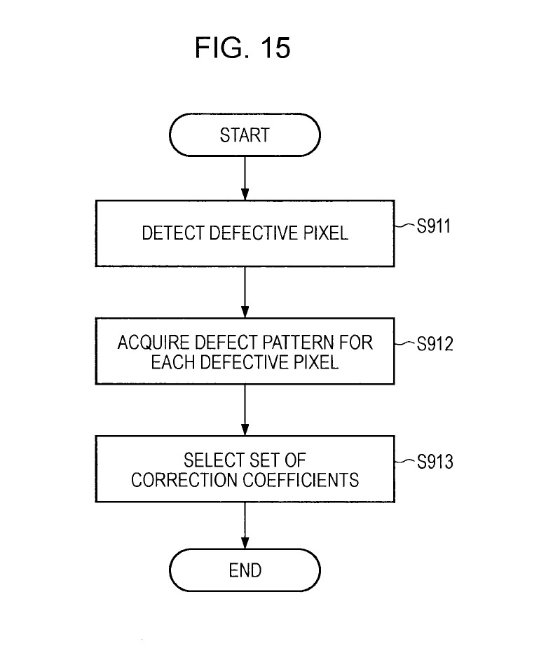

FIG. 15 is a flowchart showing an example of a defect pattern acquisition process and a correction coefficient selection process according to the second embodiment. In the second embodiment, a correction coefficient selection process is performed after a defect pattern acquisition process similar to that in the first embodiment. In the correction coefficient selection process, the correction coefficient determination unit 170 selects a set of correction coefficients corresponding to a defect pattern for each defective pixel (step S913). The correction coefficient determination unit 170 then completes the correction coefficient selection process.

As seen above, according to the second embodiment of the present technology, the imaging apparatus 100 previously stores correction coefficients in the correction coefficient storage unit 181. Thus, it can correct defective pixels without having to select correction coefficients during an image capture, speeding up the defective pixel correction process.

### 3. Third Embodiment

### Example Configuration of Imaging Apparatus

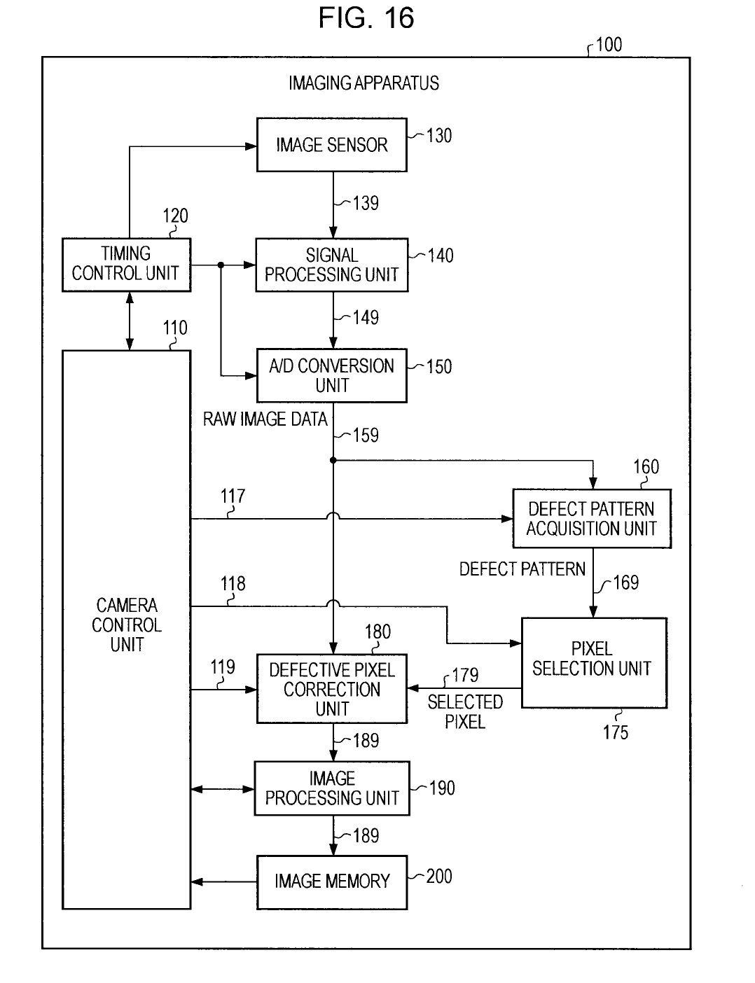

FIG. 16 is a block diagram showing an example configuration of an imaging apparatus 100 according to a third embodiment. In the first embodiment described above, pixels are selected in accordance with a defect pattern, regardless of whether there is an edge (edge) of an object in the correction block. However, when there is an edge in the correction block, correction of the defective pixel may degrade image quality if the pixels selected in accordance with the defect pattern are inappropriate. For example, if the pixels selected in accordance with the defect pattern are located on both of two areas partitioned by the edge, the edge may become partially blurred due to correction. An imaging apparatus 100 according to the third embodiment differs from that according to the first embodiment in that pixels are selected in a manner preventing blurring of an edge. Specifically, the imaging apparatus 100 according to the third embodiment differs from that according to the first embodiment in that it includes a pixel selection unit 175 in place of the correction coefficient determination unit 170.

The pixel selection unit 175 selects one or more pixels from among pixels other than defective pixels in the correction block on the basis of a defect pattern under the control of the camera control unit 110. The pixel selection unit 175 outputs the selected pixels to the defective pixel correction unit 180.

The defective pixel correction unit 180 according to the third embodiment detects an object and corrects the defective pixels in a manner preventing blurring of an edge of the area of the object.

### Example Configuration of Defective Pixel Correction Unit

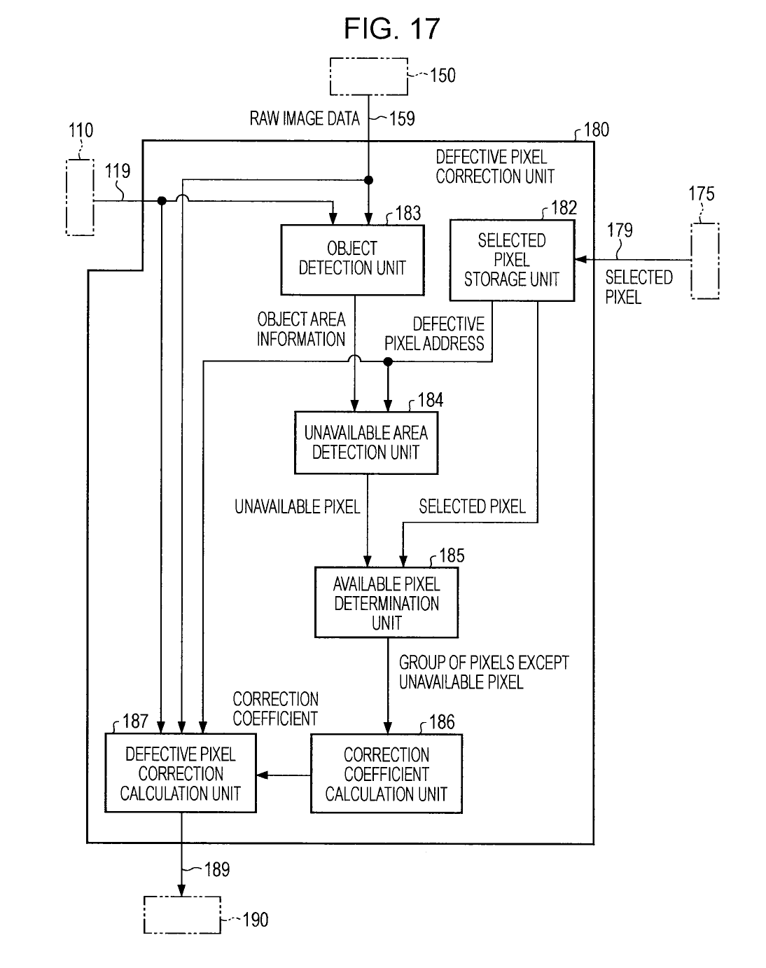

FIG. 17 is a block diagram showing an example of the defective pixel correction unit 180 according to the third embodiment. The defective pixel correction unit 180 includes a selected pixel storage unit 182, an object detection unit 183, an unavailable area detection unit 184, an available pixel determination unit 185, a correction coefficient calculation unit 186, and a defective pixel correction calculation unit 187.

The selected pixel storage unit 182 stores selected pixel designation code designating the positions of the selected pixels, for each defective pixel. The selected pixel designation code is, for example, code composed of bits corresponding to the number (e.g., eight) of pixels other than the noted pixel in the correction block. In this selected pixel designation code, the bits correspond to pixels other than the noted pixel; a value “1” is set to bits corresponding to the selected pixels, and a value “0” is set to bits corresponding to the other pixels.

The object detection unit 183 detects an edge of the area of the object in the image data. The object detection unit 183 detects an object, for example, by template matching. In template matching, data representing the image of a template for the object is previously stored; a detection area having the same size as the template is moved in inputted image data; and the detection area is compared with a detection area template. The object detection unit 183 may detect an edge of the object using methods other than template matching. For example, the object detection unit 183 may directly acquire an edge using an edge filter, such as Sobel filter or Laplacian filter, without detecting an object. The object detection unit 183 provides object area information indicating the detected object area, to the unavailable area detection unit 184. The object area information is, for example, binary image data in which the pixels in the object area are set to a value “1” and the pixels in the other areas are set to a value “0.”

The object detection unit 183 is an example of the edge detection unit in the Claims.

The unavailable area detection unit 184 selects unavailable pixels for correction from among the selected pixels for each defective pixel on the basis of the object area information and the address of the defective pixel. Specifically, the unavailable area detection unit 184 notes each defective pixel and regards, as unavailable pixels, pixels in areas other than the area including the noted pixel of the areas partitioned by the edge of the object in the correction block. The unavailable area detection unit 184 outputs unavailable pixel designation code designating the unavailable pixels, to the available pixel determination unit 185. The unavailable pixel designation code is, for example, code having the same number of bits as the selected pixel designation code. In this unavailable pixel designation code, “1” is set to bits corresponding to the unavailable pixels, and “0” is set to bits corresponding to the other pixels.

The available pixel determination unit 185 excludes the unavailable pixels from the selected pixels and determines the remaining pixels as available pixels, for each defective pixel. Specifically, the available pixel determination unit 185 outputs the selected pixel designation code to the correction coefficient calculation unit 186 in such a manner that the bits having the value “1” are masked in the unavailable pixel designation code.

The unavailable area detection unit 184 and the available pixel determination unit 185 are examples of the pixel exclusion unit in the Claims.

The correction coefficient calculation unit 186 calculates correction coefficients for each unavailable pixel. For example, the correction coefficient calculation unit 186 divides 1 by the number of bits having the value “1” in the selected pixel designation code and then regards the obtained value as a correction coefficient for each of the pixels designated by the selected pixel designation code. The correction coefficient calculation unit 186 then provides the calculated correction coefficients to the defective pixel correction calculation unit 187. The defective pixel correction calculation unit 187 corrects each defective pixel using the Formula 1 on the basis of the correction coefficients.

The correction coefficient calculation unit 186 is an example of the correction coefficient determination unit in the Claims. The defective pixel correction calculation unit 187 is an example of the defective pixel correction processing unit in the Claims.

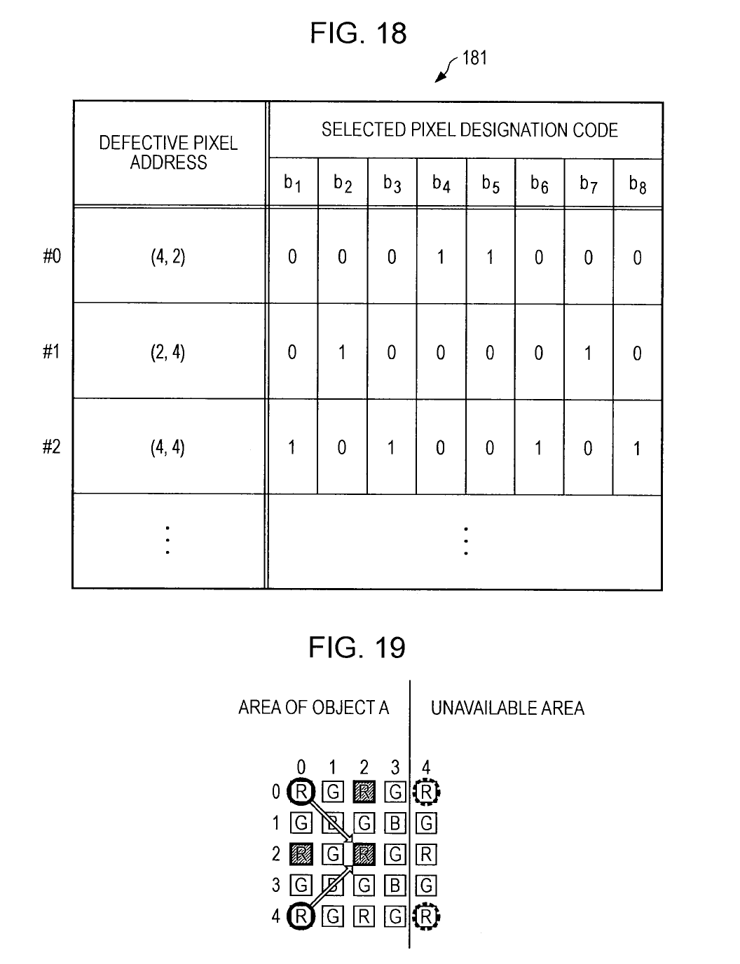

FIG. 18 is a diagram showing an example of the selected pixel designation code according to the third embodiment. The selected pixel designation code is, for example, code composed of eight bits: b₁ to b₈. Assuming that the coordinates of the noted pixel are (x,y), b₁ to b₈ are bits corresponding to pixels at (x−2,y−2), (x,y−2), (x+2,y−2), (x−2,y), (x+2,y), (x−2,y+2), (x,y+2), and (x+2,y+2). When a pixel is selected, the value “1” is set to a bit corresponding to the pixel; when the pixel is not selected, the value “0” is set to the bit corresponding to the pixel. Note that the imaging apparatus 100 may store data in a form other than that of the selected pixel designation code as long as the data can be used to identify the positions of the selected pixels. For example, the imaging apparatus 100 may store absolute coordinates of the selected pixels or relative coordinates of the selected pixels based on the noted pixel, in place of the selected pixel designation code.

### Example Operation of Imaging Apparatus

FIG. 19 is a diagram showing a defective pixel correction process according to the third embodiment. In FIG. 19, the position of the noted pixel and the shape and size of the correction block are similar to those in FIG. 9. The pixels encircled by solid lines are the remaining selected pixels except for unavailable pixels. The pixels encircled by dotted lines are unavailable pixels. A solid straight line represents an edge of an object.

Assume that the noted pixel is located at the coordinates (2,2), the corresponding defect pattern is of L-shaped type, and an edge of the object is laid between x=3 and x=4. In this case, pixels at (4,0) and (4,4) are regarded as unavailable pixels. The pixels at (4,0) and (4,4) are selected pixels in the area other than the area including the noted pixel of the areas partitioned by the edge in the correction block. The noted pixel is corrected using the remaining selected pixels at (0,0) and (0,4) except for the unavailable pixels.

As seen above, according to the third embodiment of the present technology, the imaging apparatus 100 can exclude, from the selected pixels, the pixels in the area other than the area including the noted pixel of the areas partitioned by the edge of the object and correct the noted pixel using the remaining pixels. This prevents blurring of the edge of the object in the correction, thereby improving the quality of the corrected image.

### 4. Fourth Embodiment

### Example Configuration of Correction Coefficient Learning Apparatus

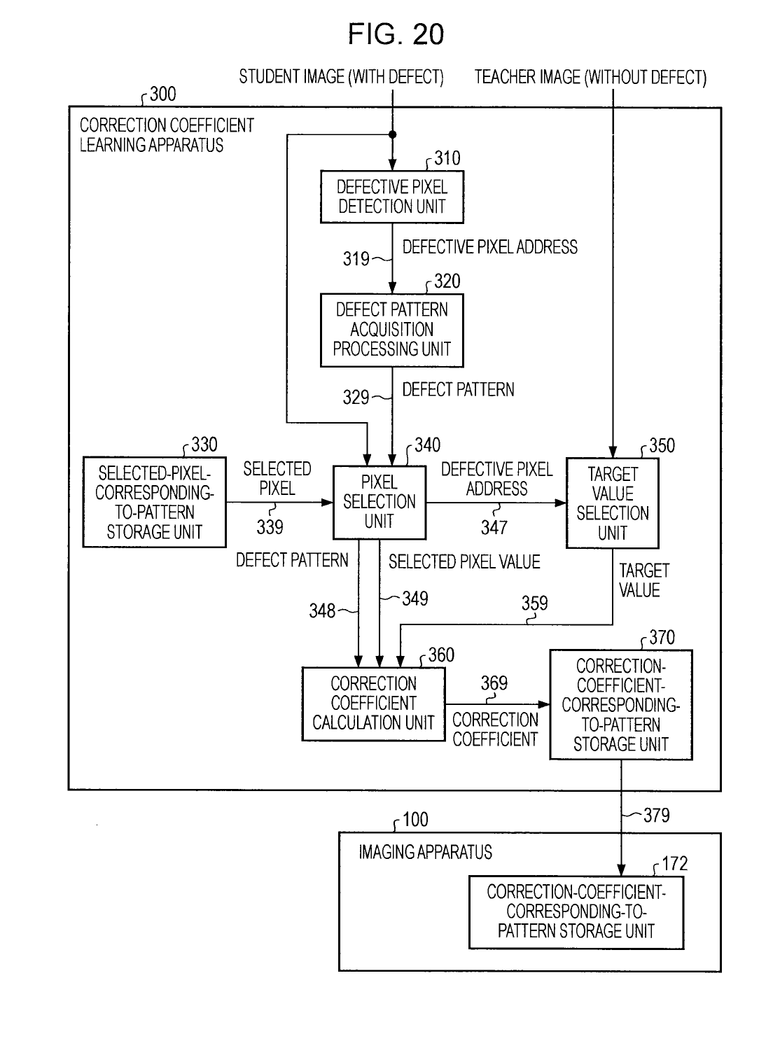

FIG. 20 shows an example of a correction coefficient learning apparatus 300 according to a fourth embodiment. The correction coefficient learning apparatus 300 learns correction coefficients from an inputted teacher image and student image. The term “teacher image” refers to an image including no defective pixel. The term “student image” refers to an image which is the same image as the teacher image but which has defective pixels at the same positions as defective pixels in the image sensor 130 of the imaging apparatus 100. One or more teacher images and one or more student images are inputted into the correction coefficient learning apparatus 300. Each student image has multiple defective pixels. The correction coefficient learning apparatus 300 detects defective pixels in a student image and learns correction coefficients such that a value obtained by correcting each defective pixel matches the value of a pixel corresponding to that defective pixel in the teacher image. Specifically, the correction coefficient learning apparatus 300 includes a defective pixel detection unit 310, a defect pattern acquisition processing unit 320, a selected-pixel-corresponding-to-pattern storage unit 330, a pixel selection unit 340, a target value selection unit 350, a correction coefficient calculation unit 360, and a correction-coefficient-corresponding-to-pattern storage unit 370.

The defective pixel detection unit 310 and the defect pattern acquisition processing unit 320 have similar configurations to the defective pixel detection unit 161 and the defect pattern acquisition processing unit 162 according to the first embodiment. In the fourth embodiment, the defective pixel detection unit 310 detects defective pixels in a student image, and the defect pattern acquisition processing unit 320 acquires a defect pattern for each defective pixel and provides it to the pixel selection unit 340.

The selected-pixel-corresponding-to-pattern storage unit 330 stores selected pixel designation code for each defect pattern. The selected pixel designation code according to the fourth embodiment has a similar data structure to that according to the third embodiment illustrated in FIG. 18.

The pixel selection unit 340 selects one or more pixels from among pixels other than defective pixels in a correction block on the basis of a defect pattern. Specifically, the pixel selection unit 340 reads selected pixel designation code corresponding to the defect pattern for each defective pixel from the selected-pixel-corresponding-to-pattern storage unit 330 via a signal line 339. The pixel selection unit 340 then provides the address of the noted defective pixel to the target value selection unit 350 via a signal line 347. The pixel selection unit 340 also provides the values of the selected pixels and the defect pattern in the student image to the correction coefficient calculation unit 360 via signal lines 348 and 349.

The target value selection unit 350 selects, as a target value, the value of a pixel corresponding to the defective pixel in the teacher image and provides the target value to the correction coefficient calculation unit 360 via a signal line 359.

The correction coefficient calculation unit 360 calculates correction coefficients corresponding to the selected pixels in such a manner that a correction value calculated from the values of the selected pixels and the correction coefficients matches the target value. For example, the correction coefficient calculation unit 360 obtains a set of correction coefficients by generating a normal equation to be discussed later and then solving the normal equation.

A method for deriving the normal equation will be described. Assume that the number of defective pixels calculated in the student image is K. A set of selected pixels corresponding to each defective pixel will be referred to as “sample.” When K number of defective pixels are detected, K number of samples and K number of target values are provided to the correction coefficient calculation unit 360. The difference eₖ between a correction value obtained from the k'th sample of the K number of samples, and a corresponding target value is obtained from Formula 2 below.

eₖ=qₖ−q′ₖ (2)

In Formula 2, qₖ represents the k'th target value, and qk′ is a correction value obtained from Formula 1 using the k'th sample. Assume that b is 0. The right side of Formula 1 obtained by replacing a pixel value pₙ with the k-th pixel value pₙ_{_{—}}ₖ is substituted for qₖ′ of Formula 2. Thus, Formula 3 below is given.

$${e}_{k} = {q}_{k} - ( {\sum }_{n = 1}^{8} {a}_{n} {p}_{n\_k} ) \qquad ( 3 )$$

An optimum set of correction coefficients is obtained by minimizing the sum of squares E represented by Formula 4 below in the least squares method.

$$E = {\sum }_{k = 1}^{K} {e}_{k}^{2} \qquad ( 4 )$$

The value of a correction coefficient that minimizes the sum of squares E in Formula 4 is a value when the partial differential of the sum of squares E using this correction coefficient becomes 0. Formula 5 below is given by partially differentiating the sum of squares E by each of correction coefficients a₁ and a₈.

$$\frac{\partial E}{\partial {a}_{1}} = 2 {e}_{1} \frac{\partial {e}_{1}}{\partial {a}_{1}} + 2 {e}_{2} \frac{\partial {e}_{2}}{\partial {a}_{1}} + ⋯ + 2 {e}_{K} \frac{\partial {e}_{K}}{\partial {a}_{1}} = 0 \\ \frac{\partial E}{\partial {a}_{2}} = 2 {e}_{1} \frac{\partial {e}_{1}}{\partial {a}_{2}} + 2 {e}_{2} \frac{\partial {e}_{2}}{\partial {a}_{2}} + ⋯ + 2 {e}_{K} \frac{\partial {e}_{K}}{\partial {a}_{2}} = 0 \\ ⋮ \\ \frac{\partial E}{\partial {a}_{8}} = 2 {e}_{1} \frac{\partial {e}_{1}}{\partial {a}_{8}} + 2 {e}_{2} \frac{\partial {e}_{2}}{\partial {a}_{8}} + ⋯ + 2 {e}_{K} \frac{\partial {e}_{K}}{\partial {a}_{8}} = 0 \qquad ( 5 )$$

A correction coefficient meeting Formula 5 is an optimum correction coefficient. Dividing both sides of Formula 5 by 2 gives Formula 6 below.

$${e}_{1} \frac{\partial e}{\partial {a}_{1}} + {e}_{2} \frac{\partial {e}_{2}}{\partial {a}_{1}} + ⋯ + {e}_{K} \frac{\partial {e}_{K}}{\partial {a}_{1}} = 0 \\ {e}_{2} \frac{\partial {e}_{1}}{\partial {a}_{2}} + {e}_{2} \frac{\partial {e}_{2}}{\partial {a}_{2}} + ⋯ + {e}_{K} \frac{\partial {e}_{K}}{\partial {a}_{2}} = 0 \\ ⋮ \\ {e}_{1} \frac{\partial {e}_{1}}{\partial {a}_{8}} + {e}_{2} \frac{\partial {e}_{2}}{\partial {a}_{8}} + ⋯ + {e}_{K} \frac{\partial {e}_{K}}{\partial {a}_{8}} = 0 \qquad ( 6 )$$

Further, partially differentiating Formula 3 by each of correction coefficients a₁ to a₈ gives Formula 7 below.

$$\frac{\partial {e}_{k}}{\partial {a}_{1}} = - {p}_{1 \_ k} , \frac{\partial {e}_{k}}{\partial {a}_{2}} = - {p}_{2 \_ k} , ⋯ , \frac{\partial {e}_{k}}{\partial {a}_{8}} = - {p}_{8 \_ k} \qquad ( 7 )$$

Substituting Formula 7 into Formula 6 gives Formula 8 below.

$${\sum }_{k = 1}^{K} {e}_{k} {p}_{1 \_ k} = 0 , {\sum }_{k = 1}^{K} {e}_{k} {p}_{2 \_ k} = 0 , ⋯ , {\sum }_{k = 1}^{K} {e}_{k} {p}_{8 \_ k} = 0 \qquad ( 8 )$$

Substituting the right side of Formula 3 for eₖ of Formula 8 gives Formula 9 below.

$${\sum }_{k = 1}^{K} ( {q}_{k} - {\sum }_{n = 1}^{8} {a}_{n} {p}_{n\_k} ) {p}_{1 \_ k} = 0 \\ {\sum }_{k = 1}^{K} ( {q}_{k} - {\sum }_{n = 1}^{8} {a}_{n} {p}_{n\_k} ) {p}_{2 \_ k} = 0 \\ ⋮ \\ {\sum }_{k = 1}^{K} ( {q}_{k} - {\sum }_{n = 1}^{8} {a}_{n} {p}_{n\_k} ) {p}_{8 \_ k} = 0 \qquad ( 9 )$$

Altering Formula 9 gives Formula 10 below.

$${\sum }_{k = 1}^{K} {p}_{1 \_ k} {p}_{1 \_ k} {a}_{1} + {\sum }_{k = 1}^{K} {p}_{1 \_ k} {p}_{2 \_ k} {a}_{2} + ⋯ + {\sum }_{k = 1}^{K} {p}_{1 \_ k} {p}_{8 \_ k} {a}_{8} = {\sum }_{k = 1}^{K} {p}_{1 \_ k} {q}_{k} \\ {\sum }_{k = 1}^{K} {p}_{2 \_ k} {p}_{1 \_ k} {a}_{1} + {\sum }_{k = 1}^{K} {p}_{2 \_ k} {p}_{2 \_ k} {a}_{2} + ⋯ + {\sum }_{k = 1}^{K} {p}_{2 \_ k} {p}_{8 \_ k} {a}_{8} = {\sum }_{k = 1}^{K} {p}_{2 \_ k} {q}_{k} \\ {\sum }_{k = 1}^{K} {p}_{8 \_ k} {p}_{1 \_ k} {a}_{1} + {\sum }_{k = 1}^{K} {p}_{8 \_ k} {p}_{2 \_ k} {a}_{2} + ⋯ + {\sum }_{k = 1}^{K} {p}_{8 \_ k} {p}_{8 \_ k} {a}_{8} = {\sum }_{k = 1}^{K} {p}_{8 \_ k} {q}_{k} \qquad ( 10 )$$

Formula 10 is represented by Formula 11 below, which is a normal equation using matrixes.

$$[ \begin{matrix}( {\sum }_{k = 1}^{K} {p}_{1 \_ k} {p}_{1 \_ k} ) & ( {\sum }_{k = 1}^{K} {p}_{1 \_ k} {p}_{2 \_ k} ) & … & ( {\sum }_{k = 1}^{K} {p}_{1 \_ k} {p}_{8 \_ k} ) \\ ( {\sum }_{k = 1}^{K} {p}_{2 \_ k} {p}_{1 \_ k} ) & ( {\sum }_{k = 1}^{K} {p}_{2 \_ k} {p}_{2 \_ k} ) & … & ( {\sum }_{k = 1}^{K} {p}_{2 \_ k} {p}_{8 \_ k} ) \\ ⋮ & ⋮ & ⋱ & ⋮ \\ ( {\sum }_{k = 1}^{K} {p}_{8 \_ k} {p}_{1 \_ k} ) & ( {\sum }_{k = 1}^{K} {p}_{8 \_ k} {p}_{2 \_ k} ) & … & ( {\sum }_{k = 1}^{K} {p}_{8 \_ k} {p}_{8 \_ k} )\end{matrix} ] [ \begin{matrix}{a}_{1} \\ {a}_{2} \\ ⋮ \\ {a}_{8}\end{matrix} ] = [ \begin{matrix}( {\sum }_{k = 1}^{k} {p}_{1 \_ k} {q}_{k} ) \\ ( {\sum }_{k = 1}^{K} {p}_{2 \_ k} {q}_{k} ) \\ ⋮ \\ ( {\sum }_{k = 1}^{K} {p}_{8 \_ k} {q}_{k} )\end{matrix} ] \qquad ( 11 )$$

Formula 11 can be solved with respect to each correction coefficient, for example, using the sweep-out method (Gauss-Jordan elimination) or the like. Thus, correction coefficients are obtained which minimize the difference between the correction value and the target value.

While Formula 11 is a normal equation when b=0 in Formula 1, the correction coefficient calculation unit 360 may further calculate b. To obtain b, Formula 12 below is used in place of Formula 11.

$$[ \begin{matrix}( {\sum }_{k = 1}^{K} {p}_{1 \_ k} {p}_{1 \_ k} ) & ( {\sum }_{k = 1}^{K} {p}_{1 \_ k} {p}_{2 \_ k} ) & … & ( {\sum }_{k = 1}^{K} {p}_{1 \_ k} {p}_{8 \_ k} ) & ( {\sum }_{k = 1}^{K} {p}_{1 \_ k} ) \\ ( {\sum }_{k = 1}^{K} {p}_{2 \_ k} {p}_{1 \_ k} ) & ( {\sum }_{k = 1}^{K} {p}_{2 \_ k} {p}_{2 \_ k} ) & … & ( {\sum }_{k = 1}^{K} {p}_{2 \_ k} {p}_{8 \_ k} ) & ( {\sum }_{k = 1}^{K} {p}_{2 \_ k} ) \\ ⋮ & ⋮ & & ⋮ & \\ ( {\sum }_{k = 1}^{K} {p}_{8 \_ k} {p}_{1 \_ k} ) & ( {\sum }_{k = 1}^{K} {p}_{8 \_ k} {p}_{2 \_ k} ) & … & ( {\sum }_{k = 1}^{K} {p}_{8 \_ k} {p}_{8 \_ k} ) & ( {\sum }_{k = 1}^{K} {r}_{8 \_ k} ) \\ ( {\sum }_{k = 1}^{K} {p}_{1 \_ k} ) & ( {\sum }_{k = 1}^{K} {p}_{2 \_ k} ) & … & ( {\sum }_{k = 1}^{K} {p}_{8 \_ k} ) & K\end{matrix} ] [ \begin{matrix}{a}_{1} \\ {a}_{2} \\ ⋮ \\ {a}_{8} \\ b\end{matrix} ] = [ \begin{matrix}{\sum }_{k = 1}^{K} {p}_{1 \_ k} {q}_{k} \\ {\sum }_{k = 1}^{K} {p}_{2 \_ k} {q}_{k} \\ ⋮ \\ {\sum }_{k = 1}^{K} {p}_{8 \_ k} {q}_{k} \\ {\sum }_{k = 1}^{K} {q}_{k}\end{matrix} ] \qquad ( 12 )$$

The correction coefficient calculation unit 360 calculates a set of correction coefficients for each defect pattern and stores it in the correction-coefficient-corresponding-to-pattern storage unit 370.

The correction coefficients stored in the correction-coefficient-corresponding-to-pattern storage unit 370 are outputted to a correction-coefficient-corresponding-to-pattern storage unit 172 in the imaging apparatus 100.

The correction coefficient learning apparatus 300 is an example of the correction coefficient calculation apparatus in the Claims.

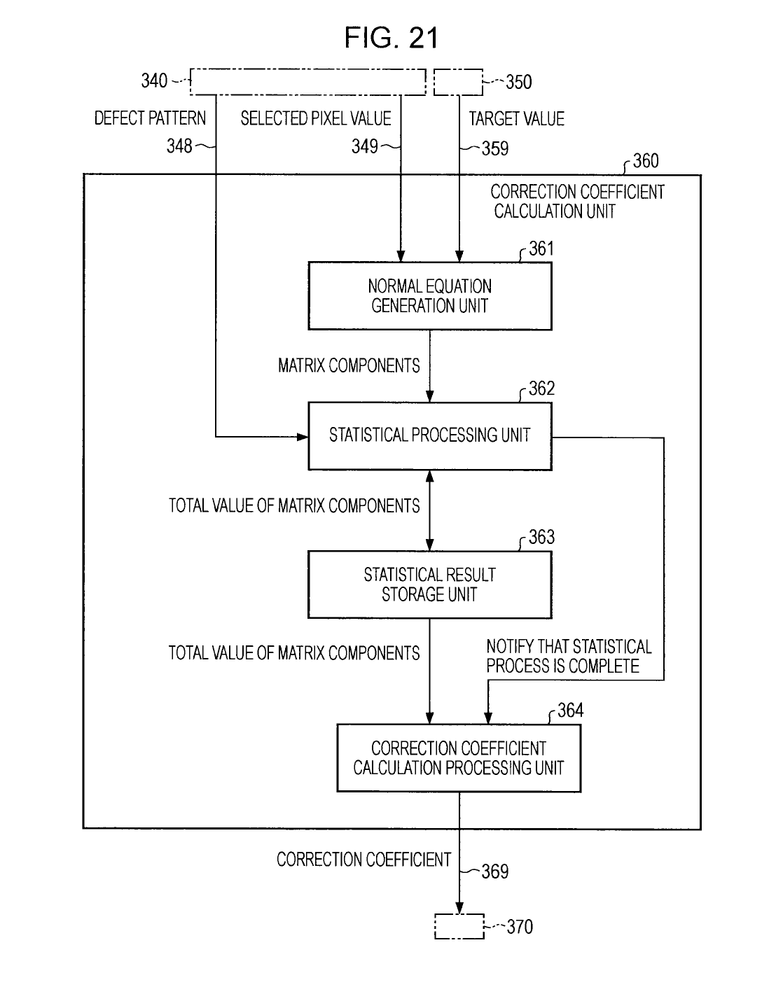

FIG. 21 is a block diagram showing an example configuration of the correction coefficient calculation unit 360 according to the fourth embodiment. The correction coefficient calculation unit 360 includes a normal equation generation unit 361, a statistical processing unit 362, a statistical result storage unit 363, and a correction coefficient calculation processing unit 364.

The normal equation generation unit 361 generates matrix elements of the normal equation illustrated as Formula 11 each time the values of selected pixels (sample) and a target value q are inputted. The normal equation generation unit 361 outputs the generated matrix elements to the statistical processing unit 362.

The statistical processing unit 362 calculates the total value of matrix elements having the same defect pattern and stores it in the statistical result storage unit 363. When the statistical process is complete in all the student images, the statistical processing unit 362 notifies the correction coefficient calculation processing unit 364 that the statistical process is complete. The statistical result storage unit 363 stores the total value of the matrix elements for each defect pattern.

The correction coefficient calculation processing unit 364 calculates correction coefficients a₁ to a₈ for each defect pattern using the normal equation illustrated as Formula 11 on the basis of the total value of the matrix elements and then outputs the correction coefficients to the correction-coefficient-corresponding-to-pattern storage unit 370.

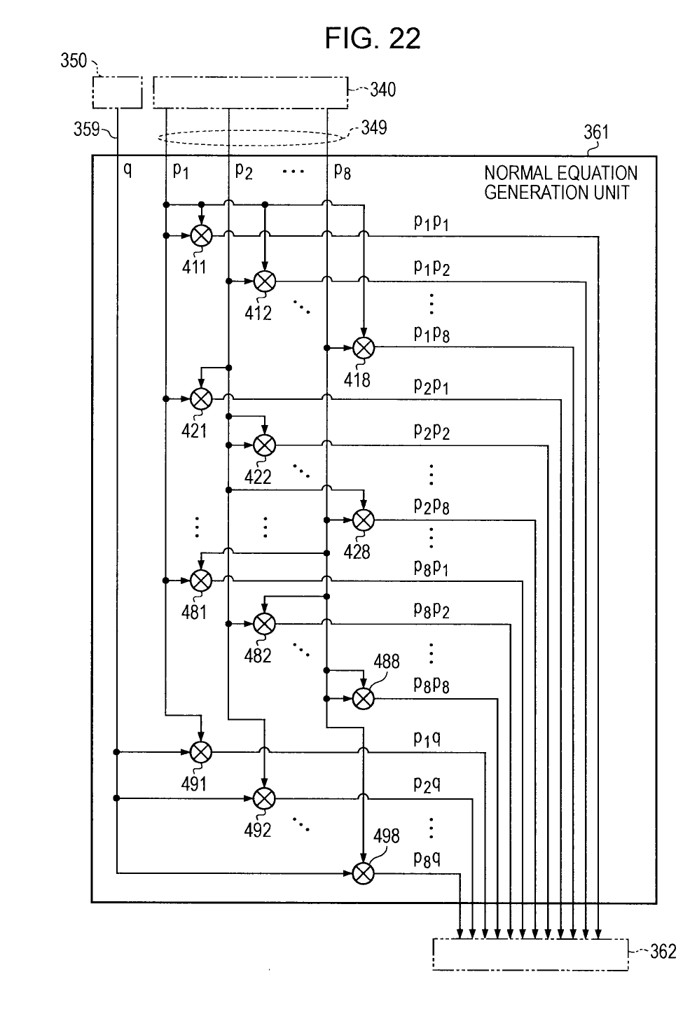

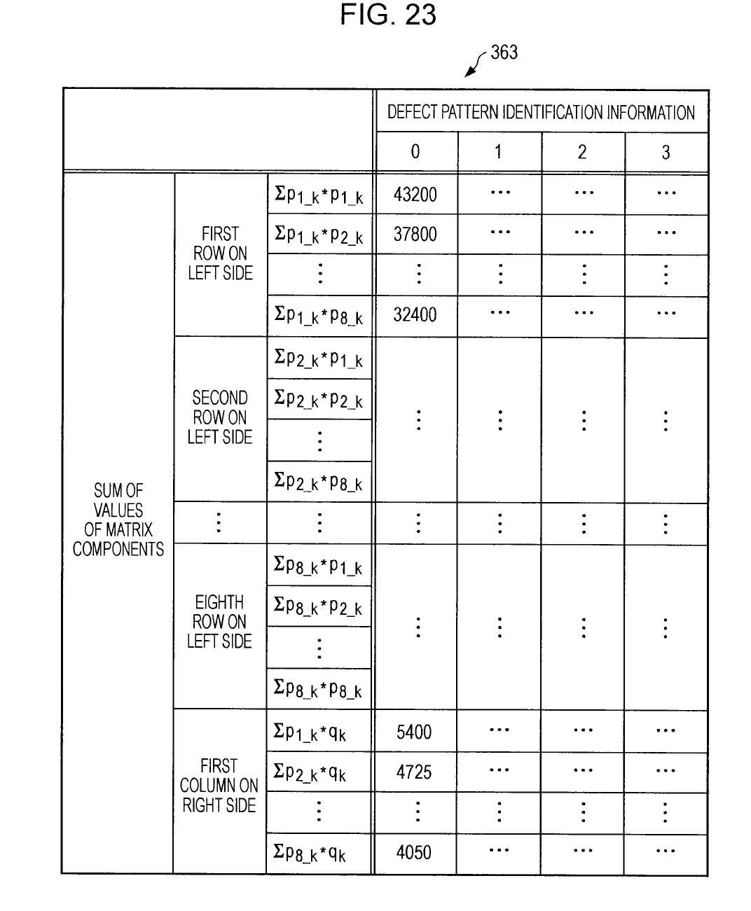

FIG. 22 is a block diagram showing an example of the normal equation generation unit 361 according to the fourth embodiment. The normal equation generation unit 361 includes multipliers 411 to 418, multipliers 421 to 428, multipliers 431 to 438, multipliers 441 to 448, multipliers 451 to 458, multipliers 461 to 468, multipliers 471 to 478, and multipliers 481 to 488. Note that in FIG. 23, the multipliers 431 to 438, the multipliers 441 to 448, the multipliers 451 to 458, the multipliers 461 to 468, and the multipliers 471 to 478 are omitted. The normal equation generation unit 361 also includes multipliers 491 to 498. The multipliers 411 to 418 obtain p₁p₁ to p₁p₁₃ by multiplying a pixel value p₁ and pixel values p₁ to p₈ and then output p₁p₁ to p₁p₁₃ as the matrix elements of the first row vector on the left side of the normal equation. The multipliers 421 to 428 output p₂p₁ to p₂p₁₃ as the matrix elements of the second row vector on the left side of the normal equal. The multipliers 431 to 438, the multipliers 441 to 448, the multipliers 451 to 458, the multipliers 461 to 468, the multipliers 471 to 478, and the multipliers 481 to 488 output the third to eighth row vectors on the left side. The multipliers 491 to 498 obtain p₁q to p₈q by multiplying the target value q and pixel values p₁ to p₈ and then output p₁q to p₈q as the matrix elements of the first column vector on the right side of the normal equation.

FIG. 23 is a diagram showing an example of the respective sums of the values of the matrix elements in the statistical result storage unit 363 according to the fourth embodiment. As shown in FIG. 23, the total value of the matrix elements is obtained by summing up the values of the matrix elements corresponding to the respective defective pixels for each defect pattern. Specifically, the total value of the matrix elements is obtained with respect to each of the first to eighth vectors on the left side of Formula 11 and the first column vector on the right side thereof.

### Example Configuration of Correction Coefficient Learning Apparatus

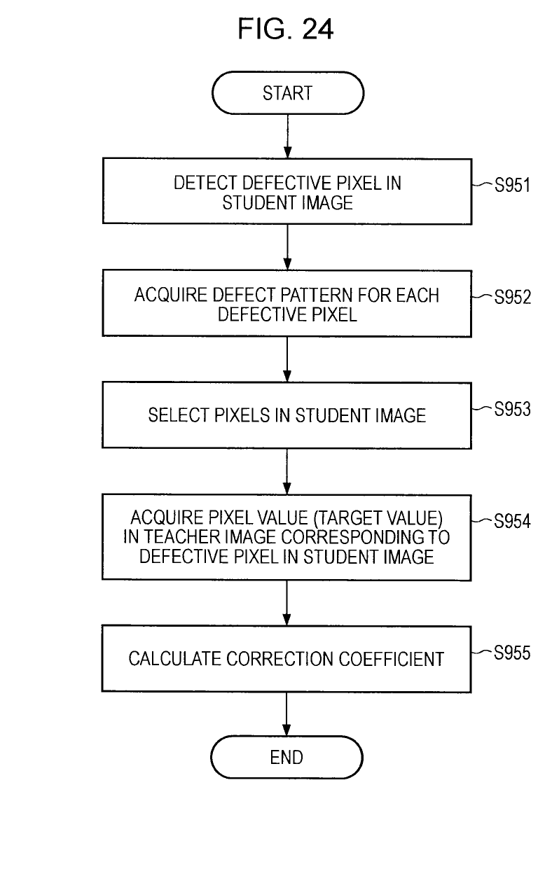

FIG. 24 is a flowchart showing an example of a correction coefficient learning process according to the fourth embodiment. This correction coefficient learning process starts, for example, when a student image and teacher image are inputted. The correction coefficient learning apparatus 300 detects defective pixels in the student image (step S951). The correction coefficient learning apparatus 300 then acquires a defect pattern for each defective pixel (step S952). The correction coefficient learning apparatus 300 then selects pixels in the correction block on the basis of the defect pattern for each defective pixel (step S953). The correction coefficient learning apparatus 300 then acquires, as a target value, the value of a pixel in the teacher image corresponding to a defective pixel in the student image (step S954). The correction coefficient learning apparatus 300 then calculates correction coefficients from the values of the selected pixels and the target value for each defect pattern using Formula 11 (step S955). The correction coefficient learning apparatus 300 then completes the correction coefficient learning process.

As seen above, according to the fourth embodiment of the present technology, the correction coefficient learning apparatus 300, each time a defective pixel is noted, can select pixels on the basis of a defect pattern, selects a target value for the defective pixel, and calculate correction coefficients from the selected pixels and the target value. Thus, optimum correction coefficients are calculated.

The above-mentioned embodiments show examples for embodying the present technology, and the matters in the embodiments correspond to the technology-specifying matters in the Claims. Similarly, the technology-specifying matters in the Claims correspond to the matters having the same names as the technology-specifying matters in the embodiments of the present technology. However, the present technology is not limited to these embodiments and can be embodied by making various changes thereto without departing from the spirit and scope of the present technology.

The process steps described in the embodiments may be construed as a method including the series of steps or as a program for causing a computer to perform the series of steps or a recording medium storing the program. Examples of such a recording medium include compact discs (CDs), MiniDiscs (MDs), digital versatile disks (DVDs), memory cards, and Blu-ray Discs®.

The present technology may be configured as follows

(1) A defective pixel correction apparatus including: a defect pattern acquisition unit configured to acquire, as a defect pattern, a pattern of positions of a plurality of defective pixels in a group of pixels used to correct a noted pixel; a pixel selection unit configured to select one or more pixels from among pixels other than the pixels in the group of pixels on the basis of the defect pattern; and a defective pixel correction unit configured to correct the noted defective pixel using the selected pixels.
(2) The defective pixel correction apparatus described in (1), further including a correction coefficient determination unit configured to determine, as a correction coefficient, a correction coefficient for calculating a correction value for a value of the noted defective pixel, for each of the selected pixels, wherein the defective pixel correction unit calculates the correction value using values of the selected pixels and the correction coefficients corresponding to the selected pixels.
(3) The defective pixel correction apparatus described in (2), further including a defect pattern storage unit configured to store the acquired defect pattern,

wherein the correction coefficient determination unit determines the correction coefficient on the basis of the defect pattern read from the defect pattern storage unit.

(4) The defective pixel correction apparatus described in (1), further including a correction coefficient storage unit configured to store, as a correction coefficient, a coefficient for calculating the correction value of the noted defective pixel, for each of the selected pixels, wherein the defective pixel correction unit reads correction coefficients corresponding to the selected pixels from the coefficient storage unit and corrects the noted defective pixel using the read correction coefficients and the selected pixels.
(5) The defective pixel correction apparatus described in any one of (1) to (4), further including a defective pixel detection unit configured to detect a defective pixel in an image, wherein the defect pattern acquisition unit acquires the defect pattern using the detected defective pixel as the noted defective pixel.
(6) The defective pixel correction apparatus described in any one of (1) to (6), wherein the defective pixel correction unit includes an edge detection unit configured to detect an edge of an object in an image; a pixel exclusion unit configured to exclude pixels in an area other than an area including the noted defective pixel of areas partitioned by the edge and output the remaining pixels; and a defective pixel correction processing unit configured to correct the noted defective pixel using the outputted pixels.
(7) A method for controlling a defective pixel correction apparatus, including: acquiring, as a defect pattern, a pattern of positions of a plurality of defective pixels in a group of pixels used to correct a noted defective pixel; selecting, by a pixel selection unit, one or more pixels from among pixels other than the defective pixels in the group of pixels on the basis of the defect pattern; and correcting, by a defective pixel correction unit, the noted defective pixel using the selected pixels.
(8) A correction coefficient calculation apparatus including: a defect pattern acquisition unit configured to acquire, as a defect pattern, a pattern of positions of a plurality of defective pixels in a group of pixels used to correct a noted defective pixel in a student image including a defective pixel; a pixel selection unit configured to select one or more pixels from among pixels other than the pixels in the group of pixels on the basis of the defect pattern each time the defective pixel is noted; a target value selection unit configured to select, as a target value, a value of a pixel corresponding to the noted defective pixel from among pixels in a teacher image including no defective pixel each time the defective pixel is noted; and a correction coefficient calculation unit configured to calculate correction coefficients corresponding to the selected one or more pixels in such a manner that a correction value calculated from the selected one or more pixels and the correction coefficients matches the target value.
(9) A method for controlling a correction coefficient calculation apparatus, including: acquiring, as a defect pattern, a pattern of positions of a plurality of defective pixels in a group of pixels used to correct a noted defective pixel in a student image including a defective pixel, by using a defect pattern acquisition unit; selecting one or more pixels from among pixels other than the defective pixels in the group of pixels on the basis of the defect pattern each time the defective pixel is noted, by using a defect pattern acquisition unit; selecting, as a target value, a value of a pixel corresponding to the noted defective pixel from among pixels in a teacher image including no defective pixel each time the defective pixel is noted, by using a target value selection unit; and calculating correction coefficients corresponding to the selected one or more pixels in such a manner that a correction value calculated from the selected one or more pixels and the correction coefficients matches the target value, by using a correction coefficient calculation unit.
(10) A program for causing a computer to perform: acquiring, as a defect pattern, a pattern of positions of a plurality of defective pixels in a group of pixels used to correct a noted defective pixel in a student image including a defective pixel, by using a defect pattern acquisition unit; selecting one or more pixels from among pixels other than the defective pixels in the group of pixels on the basis of the defect pattern each time the defective pixel is noted, by using a pixel selection unit; selecting, as a target value, a value of a pixel corresponding to the noted defective pixel from among pixels in a teacher image including no defective pixel each time the defective pixel is noted, by using a target value selection unit; and calculating correction coefficients corresponding to the selected one or more pixels in such a manner that a correction value calculated from the selected one or more pixels and the correction coefficients matches the target value, by using a correction coefficient calculation unit.

The present disclosure contains subject matter related to that disclosed in Japanese Priority Patent Application JP 2012-045736 filed in the Japan Patent Office on Mar. 1, 2012, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A defective pixel correction apparatus comprising:
a defect pattern acquisition unit configured to acquire, as a defect pattern, a pattern of positions of a plurality of defective pixels in a group of pixels used to correct a noted pixel;
a pixel selection unit configured to select one or more pixels from among pixels other than the defective pixels in the group of pixels on the basis of the defect pattern; and
a defective pixel correction unit configured to correct the noted defective pixel using the selected pixels.

2. The defective pixel correction apparatus according to claim 1, further comprising
a correction coefficient determination unit configured to determine, as a correction coefficient, a correction coefficient for calculating a correction value for a value of the noted defective pixel, for each of the selected pixels,
wherein the defective pixel correction unit calculates the correction value using values of the selected pixels and the correction coefficients corresponding to the selected pixels.

3. The defective pixel correction apparatus according to claim 2, further comprising
a defect pattern storage unit configured to store the acquired defect pattern,
wherein the correction coefficient determination unit determines the correction coefficient on the basis of the defect pattern read from the defect pattern storage unit.

4. The defective pixel correction apparatus according to claim 1, further comprising
a correction coefficient storage unit configured to store, as a correction coefficient, a coefficient for calculating a correction value for a value of the noted defective pixel, for each of the selected pixels,
wherein the defective pixel correction unit reads correction coefficients corresponding to the selected pixels from the correction coefficient storage unit and corrects the noted defective pixel using the read correction coefficients and the selected pixels.

5. The defective pixel correction apparatus according to claim 1, further comprising
a defective pixel detection unit configured to detect a defective pixel in an image,
wherein the defect pattern acquisition unit acquires the defect pattern using the detected defective pixel as the noted defective pixel.

6. The defective pixel correction apparatus according to claim 1,
wherein the defective pixel correction unit includes
an edge detection unit configured to detect an edge of an object in an image;
a pixel exclusion unit configured to exclude, from the selected pixels, pixels in an area other than an area including the noted defective pixel of areas partitioned by the edge and output the remaining pixels; and
a defective pixel correction processing unit configured to correct the noted defective pixel using the outputted pixels.

7. A method for controlling a defective pixel correction apparatus, comprising:
acquiring, as a defect pattern, a pattern of positions of a plurality of defective pixels in a group of pixels used to correct a noted defective pixel, by using a defect pattern acquisition unit;
selecting one or more pixels from among pixels other than the defective pixels in the group of pixels on the basis of the defect pattern, by using a pixel selection unit; and
correcting the noted defective pixel using the selected pixels, by using a defective pixel correction unit.

8. A correction coefficient calculation apparatus comprising:
a defect pattern acquisition unit configured to acquire, as a defect pattern, a pattern of positions of a plurality of defective pixels in a group of pixels used to correct a noted defective pixel in a student image including a defective pixel;
a pixel selection unit configured to select one or more pixels from among pixels other than the defective pixels in the group of pixels on the basis of the defect pattern each time the defective pixel is noted;
a target value selection unit configured to select, as a target value, a value of a pixel corresponding to the noted defective pixel from among pixels in a teacher image including no defective pixel each time the defective pixel is noted; and
a correction coefficient calculation unit configured to calculate correction coefficients corresponding to the selected one or more pixels in such a manner that a correction value calculated from the selected one or more pixels and the correction coefficients matches the target value.

9. A method for controlling a correction coefficient calculation apparatus, comprising:
acquiring, as a defect pattern, a pattern of positions of a plurality of defective pixels in a group of pixels used to correct a noted defective pixel in a student image including a defective pixel, by using a defect pattern acquisition unit;
selecting one or more pixels from among pixels other than the defective pixels in the group of pixels on the basis of the defect pattern each time the defective pixel is noted, by using a pixel selection unit;
selecting, as a target value, a value of a pixel corresponding to the noted defective pixel from among pixels in a teacher image including no defective pixel each time the defective pixel is noted, by using a target value selection unit; and
calculating correction coefficients corresponding to the selected one or more pixels in such a manner that a correction value calculated from the selected one or more pixels and the correction coefficients matches the target value, by using a correction coefficient calculation unit.

10. A program for causing a computer to perform:
acquiring, as a defect pattern, a pattern of positions of a plurality of defective pixels in a group of pixels used to correct a noted defective pixel in a student image including a defective pixel, by using a defect pattern acquisition unit;
selecting one or more pixels from among pixels other than the defective pixels in the group of pixels on the basis of the defect pattern each time the defective pixel is noted, by using a pixel selection unit;
selecting, as a target value, a value of a pixel corresponding to the noted defective pixel from among pixels in a teacher image including no defective pixel each time the defective pixel is noted, by using a target value selection unit; and
calculating correction coefficients corresponding to the selected one or more pixels in such a manner that a correction value calculated from the selected one or more pixels and the correction coefficients matches the target value, by using a correction coefficient calculation unit.
